(19) United States
(12) Patent Application Publication
(10) Pub. No.: US 2022/0414195 A1
(43) Pub. Date: Dec. 29, 2022

(54) INFORMATION PROCESSING APPARATUS, INFORMATION PROCESSING METHOD, AND STORAGE MEDIUM

(71) Applicant: NEC Corporation, Minato-ku, Tokyo (JP)

(72) Inventors: Osamu SAKAGUCHI, Tokyo (JP); Tomohiro HATAE, Tokyo (JP); Yoji AOKI, Tokyo (JP)

(73) Assignee: NEC Corporation, Minato-ku, Tokyo (JP)

(21) Appl. No.: 17/761,684

(22) PCT Filed: Oct. 1, 2019
(86) PCT No.: PCT/JP2019/038826

§ 371 Date: Mar. 18, 2022

(51) Int. Cl. G06F 21/32

(52) U.S. Cl. CPC G06F 21/32

(57) ABSTRACT

An information processing apparatus in the present invention includes: a receiving unit that receives request data having control data from an operation terminal used for a predetermined operation; an extraction unit that extracts biometric information used for biometric authentication and encapsulated operation data from the request data based on the control data; an authentication unit that performs biometric authentication on a user based on the biometric information; and an operation processing unit that processes the operation data.

### TECHNICAL FIELD

The present invention relates to an information processing apparatus, an information processing method, and a storage medium.

### BACKGROUND ART

Patent Literature 1 discloses a ticketless boarding system that uses passenger biometric information (face image) to perform various procedures via face authentication at a plurality of check points (a check-in lobby, a security inspection site, a boarding gate, and the like) in an airport.

### CITATION LIST

### Patent Literature

PTL 1: Japanese Patent Application Laid-Open No. 2007-79656

### SUMMARY OF INVENTION

### Technical Problem

The system disclosed in Patent Literature 1 merely discloses a configuration to use face authentication for a particular operation in an airport. However, it is expected to improve efficiency of operation by implementing a face authentication function also in various operations of transportation systems, manufacturing industry, transportation industry, retail industry, accommodation industry, and the like.

Accordingly, in view of the problem described above, the present invention intends to provide an information processing apparatus, an information processing method, and a storage medium that can easily implement a face authentication function for various operations.

### Solution to Problem

According to one aspect of the present invention, provided is an information processing apparatus including: a receiving unit that receives request data having control data from an operation terminal used for a predetermined operation; an extraction unit that extracts biometric information used for biometric authentication and encapsulated operation data from the request data based on the control data; an authentication unit that performs biometric authentication on a user based on the biometric information; and an operation processing unit that processes the operation data.

According to another aspect of the present invention, provided is an information processing method including: receiving request data having control data from an operation terminal used for a predetermined operation; extracting biometric information used for biometric authentication and encapsulated operation data from the request data based on the control data; performing biometric authentication on a user based on the biometric information; and processing the operation data.

According to yet another aspect of the present invention, provided is a storage medium storing a program that causes a computer to perform: receiving request data having control data from an operation terminal used for a predetermined operation; extracting biometric information used for biometric authentication and encapsulated operation data from the request data based on the control data; performing biometric authentication on a user based on the biometric information; and processing the operation data.

### Advantageous Effects of Invention

According to the present invention, it is possible to provide an information processing apparatus, an information processing method, and a storage medium that can easily implement a face authentication function for various operations.

### BRIEF DESCRIPTION OF DRAWINGS

FIG. 1 is a schematic diagram illustrating an example of an overall configuration of an information processing system in a first example embodiment.

FIG. 2 is a diagram illustrating an example of information stored in a token ID information DB in the first example embodiment.

FIG. 3 is a diagram illustrating an example of information stored in a passage history information DB in the first example embodiment.

FIG. 4 is a diagram illustrating an example of information stored in an operation information DB in the first example embodiment.

FIG. 5 is a function block diagram of a management server in the first example embodiment.

FIG. 6 is a diagram illustrating data structure of request data transmitted to the management server by an edge terminal in the first example embodiment.

FIG. 7 is a diagram illustrating data structure of response data transmitted to the edge server by the management server in the first example embodiment.

FIG. 8 is a block diagram illustrating an example of a hardware configuration of the management server in the first example embodiment.

FIG. 9 is a block diagram illustrating an example of a hardware configuration of a check-in terminal in the first example embodiment.

FIG. 10 is a block diagram illustrating an example of a hardware configuration of an automatic baggage check-in machine in the first example embodiment.

FIG. 11 is a block diagram illustrating an example of a hardware configuration of a security inspection apparatus in the first example embodiment.

FIG. 12 is a block diagram illustrating an example of a hardware configuration of an automated gate apparatus in the first example embodiment.

FIG. 13 is a block diagram illustrating an example of a hardware configuration of a boarding gate apparatus in the first example embodiment.

FIG. 14 is a sequence diagram illustrating an example of a process of the check-in terminal and the management server in the first example embodiment.

FIG. 15A is a diagram illustrating an example of request data transmitted to the management server by the check-in terminal in the first example embodiment.

FIG. 15B is a diagram illustrating an example of response data transmitted to the check-in terminal by the management server in the first example embodiment.

FIG. 15C is a diagram illustrating an example of request data transmitted to the management server by the check-in terminal in the first example embodiment.

FIG. 15D is a diagram illustrating an example of response data transmitted to the check-in terminal by the management server in the first example embodiment.

FIG. 16 is a sequence diagram illustrating an example of a process of the automatic baggage check-in machine and the management server in the first example embodiment.

FIG. 17A is a diagram illustrating an example of request data transmitted to the management server by the automatic baggage check-in machine in the first example embodiment.

FIG. 17B is a diagram illustrating an example of response data transmitted to the automatic baggage check-in machine by the management server in the first example embodiment.

FIG. 18 is a sequence diagram illustrating an example of a process of the security inspection apparatus and the management server in the first example embodiment.

FIG. 19 is a sequence diagram illustrating an example of a process of the automated gate apparatus and the management server in the first example embodiment.

FIG. 20 is a sequence diagram illustrating an example of a process of the boarding gate apparatus and the management server in the first example embodiment.

FIG. 21 is a schematic diagram illustrating an example of an overall configuration of an information processing system in a second example embodiment.

FIG. 22 is a function block diagram of a management server in the second example embodiment.

FIG. 23 is a block diagram illustrating an example of a hardware configuration of an automatic ticket vending machine in the second example embodiment.

FIG. 24 is a block diagram illustrating an example of a hardware configuration of an automatic ticket gate in the second example embodiment.

FIG. 25 is a block diagram illustrating an example of a hardware configuration of a POS terminal in the second example embodiment.

FIG. 26 is a sequence diagram illustrating an example of a process of an automatic ticket vending machine and the management server in the second example embodiment.

FIG. 27 is a diagram illustrating an example of a screen displayed on the automatic ticket vending machine in the second example embodiment.

FIG. 28 is a diagram illustrating an example of a screen displayed on the automatic ticket vending machine in the second example embodiment.

FIG. 29A is a diagram illustrating an example of request data transmitted to the management server by the automatic ticket vending machine in the second example embodiment.

FIG. 29B is a diagram illustrating an example of response data transmitted to the automatic ticket vending machine by the management server in the second example embodiment.

FIG. 30 is a flowchart illustrating an example of a process of the management server in the second example embodiment.

FIG. 31 is a sequence diagram illustrating an example of a process of the automatic ticket gate and the management server in the second example embodiment.

FIG. 32A is a diagram illustrating an example of request data transmitted to the management server by the automatic ticket gate in the second example embodiment.

FIG. 32B is a diagram illustrating an example of response data transmitted to the automatic ticket gate by the management server in the second example embodiment.

FIG. 33 is a sequence diagram illustrating an example of a process of the POS terminal and the management server in the second example embodiment.

FIG. 34A is a diagram illustrating an example of request data transmitted to the management server by the POS terminal in the second example embodiment.

FIG. 34B is a diagram illustrating an example of response data transmitted to the POS terminal by the management server in the second example embodiment.

FIG. 35 is a sequence diagram illustrating an example of a process of the automatic ticket gate and the management server in the second example embodiment.

FIG. 36 is a block diagram illustrating a configuration of an information processing apparatus in a third example embodiment.

### DESCRIPTION OF EMBODIMENTS

Exemplary embodiments of the present invention will be described below with reference to the drawings. Throughout the drawings, the same or corresponding components are labeled with the same references, and the description thereof may be omitted or simplified.

### First Example Embodiment

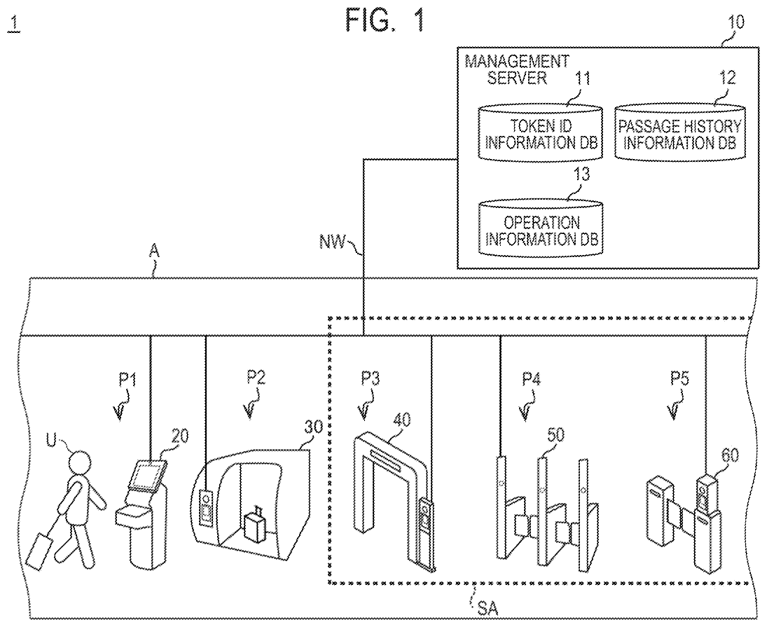

FIG. 1 is a schematic diagram illustrating an example of an overall configuration of an information processing system 1 in the present example embodiment. The information processing system 1 is a computer system that supports operations related to a series of inspection procedures performed on a user (passenger) U using an airport A. The information processing system is operated by a public institution such as an immigration control bureau or a trustee entrusted with the operation from such an institution, for example.

In the information processing system 1 of the present example embodiment, a check-in terminal 20, an automatic baggage check-in machine 30, a security inspection apparatus 40, an automated gate apparatus 50, and a boarding gate apparatus 60 are connected to a shared management server 10 via a network NW, respectively. The security inspection apparatus 40, the automated gate apparatus 50, and the boarding gate apparatus 60 are installed in a security area SA illustrated by a dashed line. The network NW is formed of a local area network (LAN) including a private communication network of the airport A, a wide area network (WAN), a mobile communication network, or the like. The connection scheme may be a wireless scheme without being limited to a wired scheme. Note that, for simplified illustration, FIG. 1 illustrates only terminal apparatuses (operation terminals) used for procedures for departure from a country via the airport A.

The management server 10 is an information processing apparatus that manages operations related to inspection procedures in immigration of the user U. The management server 10 is installed in a facility of an airport company operating the airport A, an airline company, or the like, for example. Further, the management server 10 may be a cloud server instead of a server installed in the facility in which operations are actually performed. Note that the management server 10 is not necessarily required to be a single server and may be formed as a server group including a plurality of servers.

As illustrated in FIG. 1, the inspection procedures in the airport A for departure from a country are sequentially performed at five touch points P1 to P5. The relationship between each apparatus and the touch points P1 to P5 will be described below.

The check-in terminal 20 is installed in a check-in lobby (hereafter, referred to as “touch point P1”) in the airport A. The check-in terminal 20 is a self-service terminal operated by the user U by himself/herself to perform a check-in procedure. The check-in terminal 20 is also called a Common Use Self Service (CUSS) terminal. After completion of the check-in procedure at the touch point P1, the user U moves to a baggage check-in place or a security inspection site.

The automatic baggage check-in machine 30 is installed in a region adjacent to a baggage counter (manned counter) in the airport A or a region near the check-in terminal 20 (hereafter, referred to as “touch point P2”). The automatic baggage check-in machine 30 is a self-service terminal operated by the user U by himself/herself to perform a procedure to check in baggage not carried in the aircraft (baggage check-in procedure). The automatic baggage check-in machine 30 is also called a Common Use Bag Drop (CUBD) terminal. After completion of the baggage check-in procedure, the user U moves to the security inspection site. Note that, when the user U does not check in his/her baggage, the procedure at the touch point P2 is omitted.

The security inspection apparatus 40 is installed in the security inspection site (hereafter, referred to as “touch point P3”) in the airport A. The security inspection apparatus 40 is an apparatus that uses a metal detector to check whether or not the user U is wearing a metal object that may be a dangerous object. Note that the term “security inspection apparatus” in the present example embodiment is used as a meaning including not only a metal detector but also an X-ray inspection device that uses an X-ray to check whether or not there is a dangerous object in carry-on baggage or the like, a terminal device of a Passenger Reconciliation System (PRS) that determines whether or not to permit passage of the user U at the entrance of a security inspection site, or the like. After completion of the security inspection procedure with the security inspection apparatus 40 at the touch point P3, the user U moves to a departure inspection site.

The automated gate apparatus 50 is installed in the departure inspection site (hereafter, referred to as “touch point P4”) in the airport A. The automated gate apparatus 50 is an apparatus that automatically performs a departure inspection procedure on the user U. After completion of the departure inspection procedure at the touch point P4, the user U moves to a departure area where duty free shops or boarding gates are provided.

The boarding gate apparatus 60 is a passage control apparatus each installed at a boarding gate (hereafter, referred to as “touch point P5”) of the departure area. The boarding gate apparatus 60 is also called an Automated Boarding Gates (ABG) terminal. The boarding gate apparatus 60 confirms that the user U is a passenger of an aircraft that is available for boarding through the boarding gate. After completion of the procedure at the touch point P5, the user U boards the aircraft and departs from the country to a second country.

Further, as illustrated in FIG. 1, the management server 10 has a token ID information DB 11, a passage history information DB 12, and an operation information DB 13. Note that the database included in the management server 10 is not limited to these databases.

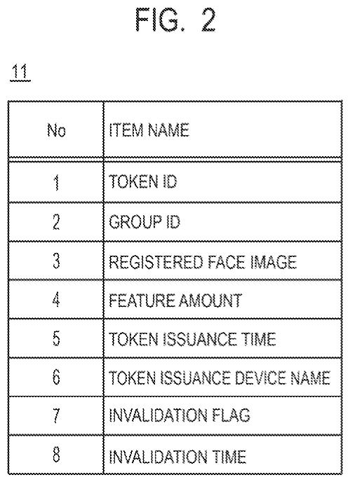

FIG. 2 is a diagram illustrating an example of information stored in the token ID information DB 11. The token ID information DB 11 has data items of a token ID, a group ID, a registered face image, a feature amount, a token issuance time, a token issuance device name, an invalidation flag, and an invalidation time. The token ID is an identifier that uniquely identifies ID information. The token ID in the present example embodiment is temporarily issued provided that there is a matching in a result of matching between a face image in which the user U possessing a passport is captured at the touch point P1 and a passport face image read from the passport. The token ID is then invalidated once the user U completes a procedure at the touch point P5 (boarding gate). That is, the token ID is not an identifier to be permanently used but as a one-time ID having a validated period (lifecycle).

The group ID is an identifier used for grouping ID information. The registered face image is a face image registered for the user U. The feature amount is a value extracted from biometric information (registered face image). Note that, although the term of biometric information in the present example embodiment means a face image or a feature amount extracted from a face image, biometric information is not limited to a face image or a face feature amount. That is, biometric authentication may be performed by using an iris image, a fingerprint image, a palmprint image, an auricle image, or the like as biometric information on the user U.

The token issuance time is a time that the management server 10 issued a token ID. The token issuance device name is a device name of an acquisition source of a registered face image that triggered issuance of a token ID. The invalidation flag is flag information indicating whether or not the token ID is currently valid. In response to issuance of a token ID, the invalidation flag in the present example embodiment becomes a value of “1” indicating a state where the token ID is valid. Further, if a predetermined condition is satisfied, the invalidation flag is updated to a value of “0” indicating a state where the token ID is invalid. The invalidation time is a timestamp of a time that the invalidation flag was invalidated.

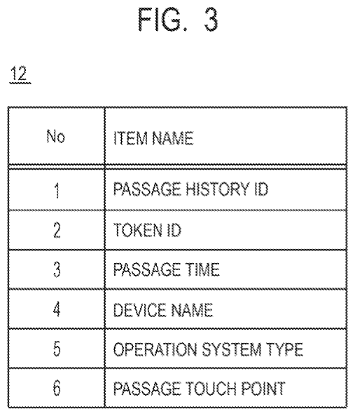

FIG. 3 is a diagram illustrating an example of information stored in the passage history information DB 12. The passage history information DB 12 has data items of a passage history ID, a token ID, a passage time, a device name, an operation system type, and a passage touch point. The passage history ID is an identifier that uniquely identifies passage history information. The passage time is a timestamp at passage of a touch point. The device name is a machine name of an operation terminal used in a procedure at a touch point. The operation system type is a type of an operation system to which an operation terminal belongs. Note that, by extracting passage history information on a token ID basis, the management server 10 can know up to which touch point the user U has completed procedures.

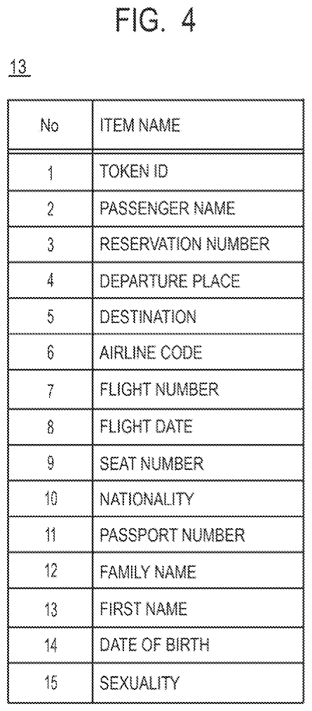

FIG. 4 is a diagram illustrating an example of information stored in the operation information DB 13. The operation information DB 13 has data items of a token ID, a passenger name, a reservation number, a departure place, a destination, an airline code, a flight number, a flight date, a seat number, a nationality, a passport number, a family name, a first name, a date of birth, and a sexuality. In such a way, the operation information DB 13 stores operation information related to predetermined operations on a token ID basis. In the present example embodiment, “predetermined operation” means a procedure operation performed at each of the touch points P1 to P5.

The reservation number is an identifier that uniquely identifies boarding reservation information. The airline code is an identifier that uniquely identifies an airline company. Boarding reservation information included in operation information may be a passenger name, a reservation number, a departure place, a destination, an airline code, a flight number, a flight date, a seat number, a nationality, a passport number, a family number, a first name, a date of birth, a sexuality, or the like. The boarding reservation information can be acquired from a recording medium such as a passport, a boarding ticket, or the like. Further, the boarding reservation information can also be acquired from a reservation system (not illustrated) of an airline company by using a passport number, a reservation number, or the like as a key. The acquired boarding reservation information is then stored as operation information in the operation information DB 13.

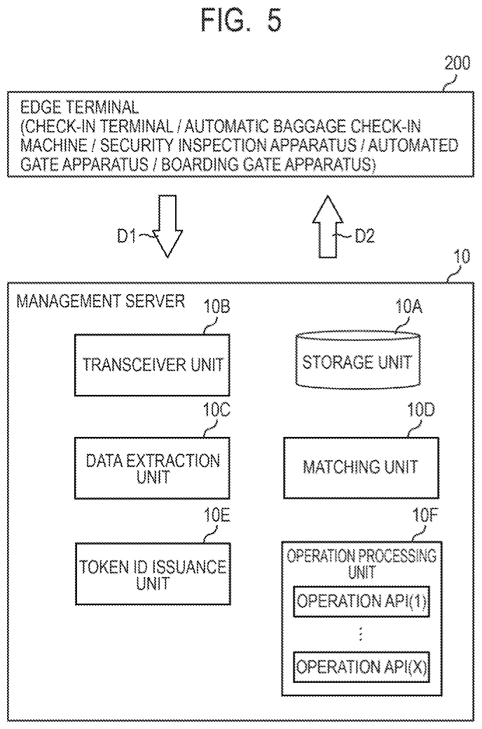

FIG. 5 is a function block diagram of the management server 10. As illustrated in FIG. 5, the management server 10 has a storage unit 10A, a transceiver unit 10B, a data extraction unit 10C, a matching unit 10D, a token ID issuance unit 10E, and an operation processing unit 10F. Note that the function of the management server 10 is not limited to what is illustrated.

The storage unit 10A stores token ID information, passage history information, operation information, and the like described above. The transceiver unit 10B receives request data D1 from an edge terminal 200 and transmits a process result in the management server 10 to the edge terminal 200 as response data D2. Note that the edge terminal 200 in the present example embodiment corresponds to each terminal device of the check-in terminal 20, the automatic baggage check-in machine 30, the security inspection apparatus 40, the automated gate apparatus 50, and the boarding gate apparatus 60.

The data extraction unit 10C determines an API of a calling target based on a command included in the received request data D1, extracts control data, face authenticating data, and operation data included in the request data D1, and assigns these data to each API.

If it is determined that the command content indicates “token ID issuance request” in the data extraction unit 10C, the matching unit 10D matches a target face image extracted from the request data D1 with a passport face image. Further, if it is determined that the command content indicates “face authentication execution request” in the data extraction unit 10C, the matching unit 10D matches a target face image extracted from the request data D1 with a face image of a registrant (registered face image) stored in the storage unit 10A. If the result of matching of the target face image with the passport face image performed by the matching unit 10D is that the matching is successful, the token ID issuance unit 10E issues a token ID to the user U.

The operation processing unit 10F is a set of X (X≥1) API(s) that performs data processing related to an operation(s) and is called by the data extraction unit 10C. For example, when the transceiver unit 10B receives the request data D1 from the automatic baggage check-in machine 30, the data extraction unit 10C first calls and causes the matching unit 10D to perform a matching process and, based on the result of matching, calls an operation API related to the baggage check-in procedure. In such a way, since the matching unit 10D or any operation API can be started in accordance with data extracted by the data extraction unit 10C, a face authentication technology can be easily applied to various operations.

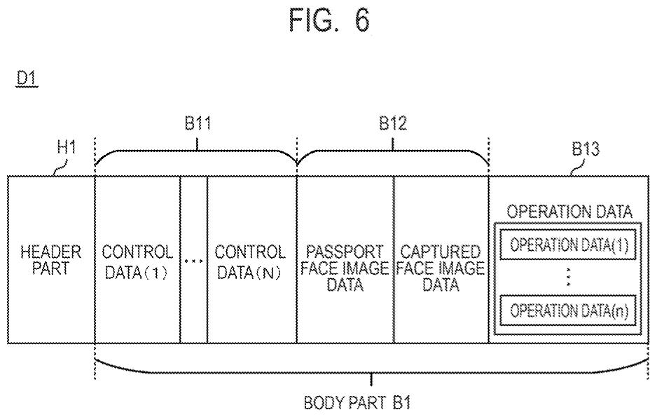

FIG. 6 is a diagram illustrating data structure of the request data D1 transmitted to the management server 10 by the edge terminal 200. The request data D1 is formed of a header part H1 and a body part B1. The header part H1 is a field storing control data such as a communication protocol, authentication information, information on a request method (POST, GET, or the like), a command, and a medium type of a resource, and the like.

The body part B1 is a field storing control data B11, face authenticating data B12, and operation data B13. The control data B11 is data used for controlling the operation of operation APIs and made up of data items that do not depend on the operation. The control data B11 differs in the control target from the control data stored in the header part H1. The control data of the header part H1 includes an execution command related to at least one of an operation data registration process, an operation data search process, a token ID issuance process, and biometric authentication. In contrast, the control data B11 of the body part B1 includes data items of a device name of a source of the request data D1, a system type, a location, and the like.

Further, in FIG. 6, two data, namely, passport face image data and captured face image data are stored as the face authenticating data B12. Further, the operation data B13 is a data group encapsulating n (n≥1) operation data, and one label is provided for each operation data B13. In the operation data B13, individual operation data (1) to (n) are stored in a lower layer and used for the process of the operation processing unit 10F. Further, labels are provided for the operation data (1) to (n), respectively, in order to make data items identifiable.

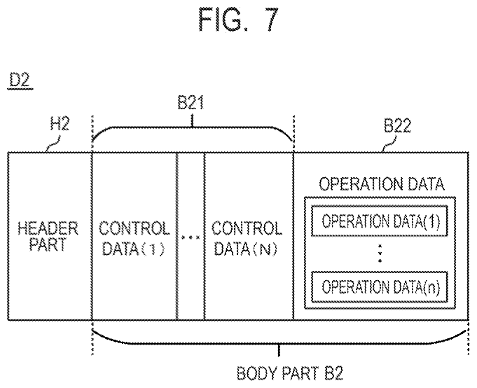

FIG. 7 is a diagram illustrating data structure of the response data D2 transmitted to the edge terminal 200 by the management server 10. The response data D2 is formed of a header part H2 and a body part B2. Unlike the case of the request data D1, the response data D2 does not include face authenticating data. Further, the body part B2 is a field to store control data B21 and operation data B22. Note that, while the configuration of the header part H2 and the body part B2 is similar to that of the header part H1 and the body part B1 illustrated in FIG. 6, the type of data items to be stored may not be necessarily required to be the same.

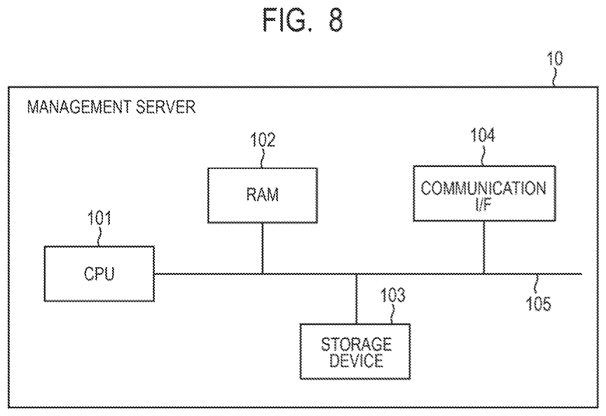

Subsequently, the hardware configuration of respective devices forming the information processing system 1 will be described with reference to FIG. 8 to FIG. 13. Note that, in FIG. 8 to FIG. 13, devices having the same name but different references are devices having substantially the same function, and the detailed description thereof will thus be omitted in subsequent drawings.

FIG. 8 is a block diagram illustrating an example of the hardware configuration of the management server 10. As illustrated in FIG. 8, the management server 10 has a central processing unit (CPU) 101, a random access memory (RAM) 102, a storage device 103, and a communication I/F 104. Each device is connected to a bus line 105.

The CPU 101 is a processor having a function of performing a predetermined operation in accordance with a program stored in the storage device 103 and controlling each component of the management server 10. In the management server 10, the CPU 101 functions as the transceiver unit 10B, the data extraction unit 10C, the matching unit 10D, the token ID issuance unit 10E, and the operation processing unit 10F described above. The RAM 102 is formed of a volatile storage medium and provides a temporary memory area required for the operation of the CPU 101.

The storage device 103 is formed of a storage medium such as a nonvolatile memory, a hard disk drive, or the like and functions as the storage unit 10A. The storage device 103 stores a program executed by the CPU 101, data referenced by the CPU 101 in execution of the program, or the like.

The communication I/F 104 is a communication interface based on a specification such as Ethernet (registered trademark), Wi-Fi (registered trademark), 4G, or the like and is a module for communicating with the check-in terminal 20 or the like. The communication I/F 104 functions as the transceiver unit 10B together with the CPU 101.

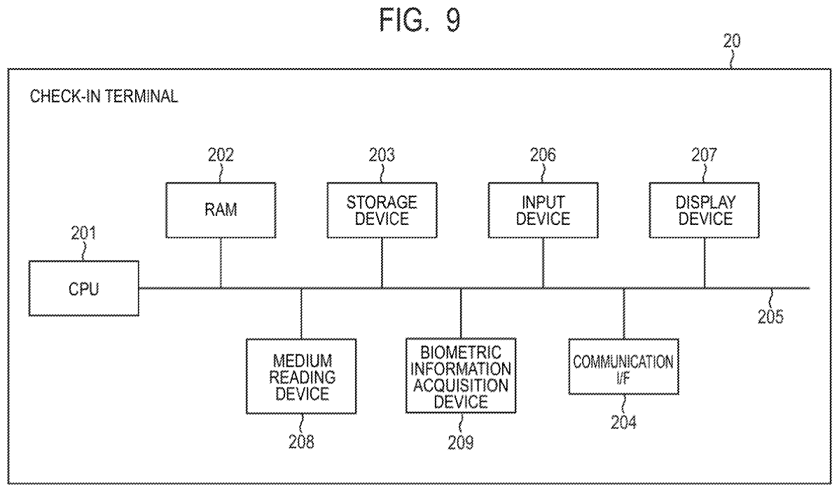

FIG. 9 is a block diagram illustrating an example of the hardware configuration of the check-in terminal 20. As illustrated in FIG. 9, the check-in terminal 20 has a CPU 201, a RAM 202, a storage device 203, a communication I/F 204, an input device 206, a display device 207, a medium reading device 208, and a biometric information acquisition device 209. Each device is connected to a bus line 205.

The input device 206 is a pointing device such as a touch panel, a keyboard, or the like, for example. In the check-in terminal 20 of the present example embodiment, the display device 207 and the input device 206 are integrally formed as a touch panel. The display device 207 is a liquid crystal display device, an organic light emitting diode (OLED) display device, or the like and is used for displaying a moving image, a still image, a text, or the like.

The medium reading device 208 is a device that reads a medium such as a passport, an airline ticket, or the like of the user U and acquires information recorded in the medium. The airline ticket medium may be, for example, a paper airline ticket, a mobile terminal displaying an e-ticket receipt, or the like. The medium reading device 208 is formed of a code reader, an image scanner, a contactless integrated circuit (IC) reader, an optical character reader (OCR) device, or the like, for example, and acquires information from various media presented to the reading unit thereof.

The biometric information acquisition device 209 is a device that acquires a face image of the user U as biometric information on the user U. The biometric information acquisition device 209 is, for example, a digital camera used for capturing a face of the user U standing in front of the check-in terminal 20 and captures the face of the user U to acquire the face image.

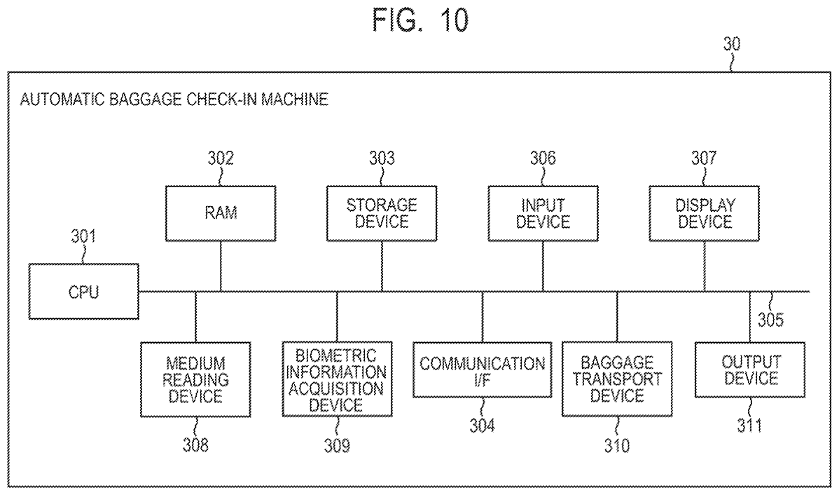

FIG. 10 is a block diagram illustrating an example of the hardware configuration of the automatic baggage check-in machine 30. As illustrated in FIG. 10, the automatic baggage check-in machine 30 has a CPU 301, a RAM 302, a storage device 303, a communication I/F 304, an input device 306, a display device 307, a medium reading device 308, a biometric information acquisition device 309, a baggage transport device 310, and an output device 311. Each device is connected to a bus line 305.

The baggage transport device 310 is a device that transports baggage of the user U for loading the baggage to the aircraft that the user U boards. The baggage transport device 310 transports, to a baggage handling place, baggage which is placed on receiving part by the user U and to which a baggage tag is attached.

The output device 311 is a device that outputs a baggage tag to be attached to checking-in baggage. Further, the output device 311 outputs a baggage claim tag that is necessary when the user U claims his/her baggage after arriving at the destination. Note that a baggage tag or a baggage claim tag is associated with at least one of a passport number, a reservation number, and a token ID.

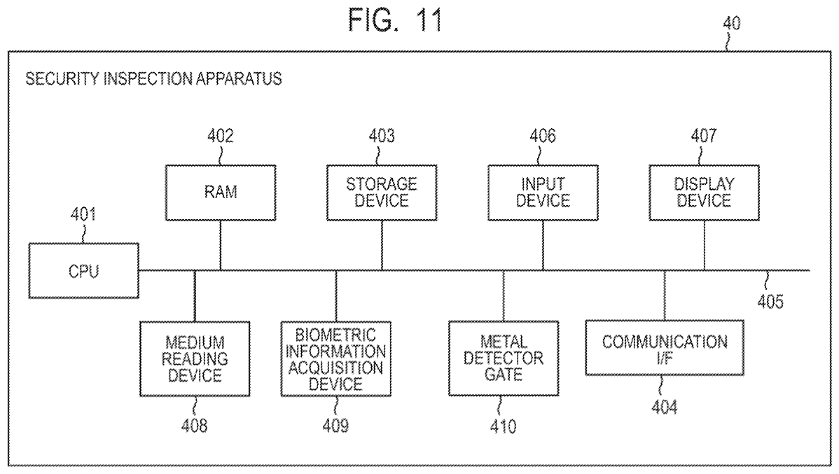

FIG. 11 is a block diagram illustrating an example of the hardware configuration of the security inspection apparatus 40. As illustrated in FIG. 11, the security inspection apparatus 40 has a CPU 401, a RAM 402, a storage device 403, a communication I/F 404, an input device 406, a display device 407, a medium reading device 408, a biometric information acquisition device 409, and a metal detector gate 410. Each device is connected to a bus line 405.

The metal detector gate 410 is a gate type metal detector and detects a metal object worn by the user U passing through the metal detector gate 410.

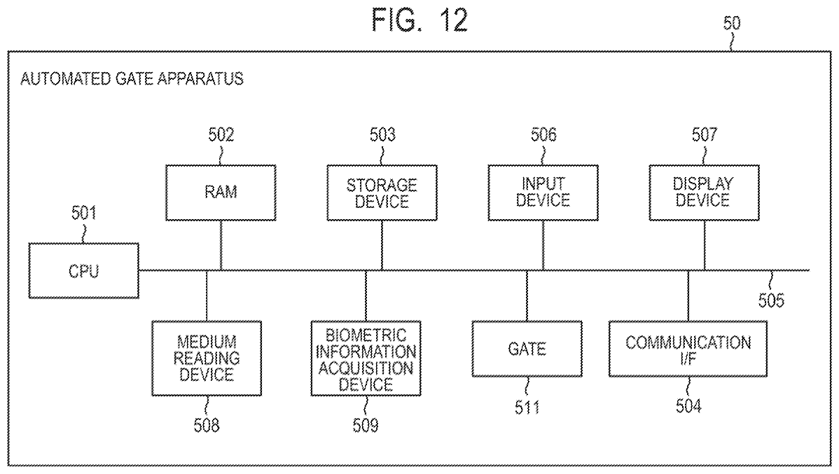

FIG. 12 is a block diagram illustrating an example of the hardware configuration of the automated gate apparatus 50. The automated gate apparatus 50 has a CPU 501, a RAM 502, a storage device 503, a communication I/F 504, an input device 506, a display device 507, a medium reading device 508, a biometric information acquisition device 509, and a gate 511. Each device is connected to a bus line 505.

The gate 511 transitions from a closed state to block passage of the user U during standby to an open state to permit passage of the user U under the control of the CPU 501 when identity verification of the user U at the automated gate apparatus 50 is successful and the user U has passed through the departure inspection. The scheme of the gate 511 is not particularly limited, and the gate 511 may be, for example, a flapper gate in which one or more flappers provided to one side or both sides of a passage are opened and closed, a turn style gate in which three bars are revolved, or the like.

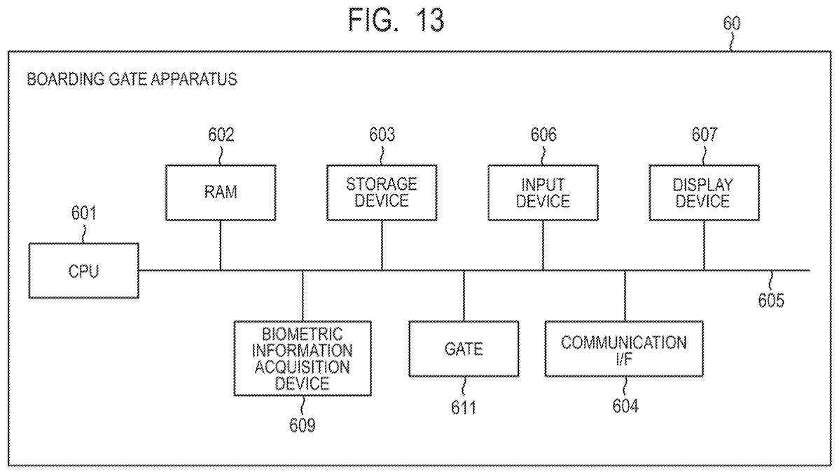

FIG. 13 is a block diagram illustrating an example of the hardware configuration of the boarding gate apparatus 60. As illustrated in FIG. 13, the boarding gate apparatus 60 has a CPU 601, a RAM 602, a storage device 603, a communication I/F 604, an input device 606, a display device 607, a biometric information acquisition device 609, and a gate 611. Each device is connected to a bus line 605.

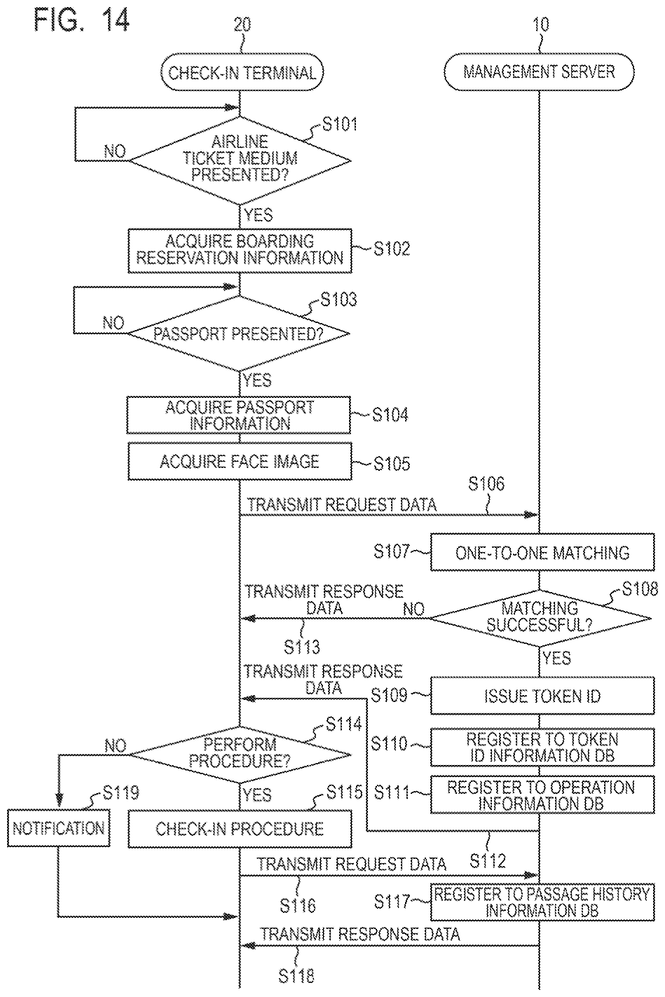

Subsequently, the operation of each apparatus in the information processing system 1 in the present example embodiment will be described with reference to FIG. 14 to FIG. 20.

### [Check-In Procedure]

FIG. 14 is a sequence diagram illustrating an example of the process of the check-in terminal 20 and the management server 10. This process is performed when the user U uses the check-in terminal 20 to perform a check-in procedure.

First, the check-in terminal 20 determines whether or not an airline ticket medium of the user U is presented to the reading unit (not illustrated) of the medium reading device 208 (step S101) and stands by until an airline ticket medium is presented (step S101, NO).

Next, if the check-in terminal 20 determines that an airline ticket medium is presented to a reading unit of the medium reading device 208 (step S101, YES), the check-in terminal 20 acquires boarding reservation information on the user U from the presented airline ticket medium (step S102). The acquired boarding reservation information includes a family name, a first name, an airline code, a flight number, a boarding date, a departure place (boarding airport), a destination (arrival airport), a seat number, a boarding time, an arrival time, or the like.

Next, the check-in terminal 20 determines whether or not a passport of the user U is presented to the reading unit of the medium reading device 208 (step S103) and stands by until a passport is presented (step S103, NO).

Next, if the check-in terminal 20 determines that a passport is presented to the reading unit of the medium reading device 208 (step S103, YES), the check-in terminal 20 acquires passport information on the user U from the presented passport (step S104). The acquired passport information includes a passport face image of the user U, identity verification information, a passport number, a passport issuance country, or the like.

Next, the check-in terminal 20 captures a face of the user U by the biometric information acquisition device 209 and acquires a face image as a target face image (step S105). Note that it is preferable to display a guidance message related to capturing of a face image (for example, “By registering your face image, you can easily perform the following procedures required before departure through face recognition. The registered face image will be deleted from the system after boarding is completed.”) on a screen and obtain the consent of the user U before capturing a face image.

Next, the check-in terminal 20 transmits the request data D1 that requests matching of the face image and issuance of a token ID to the management server 10 (step S106).

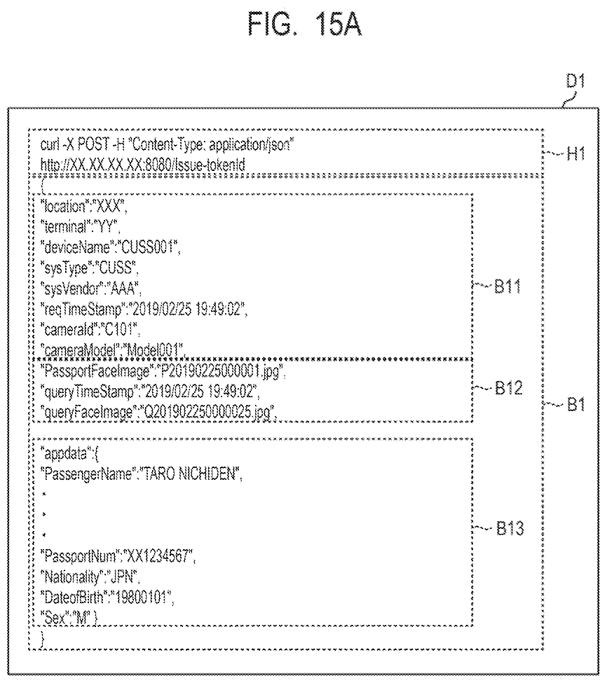

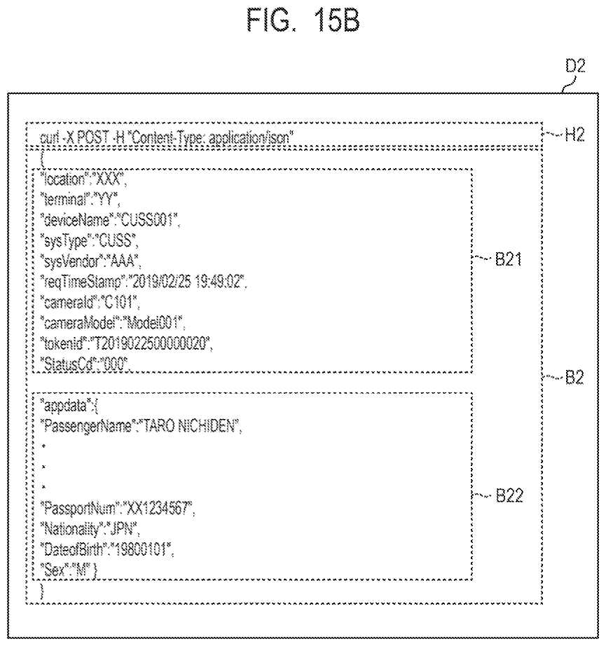

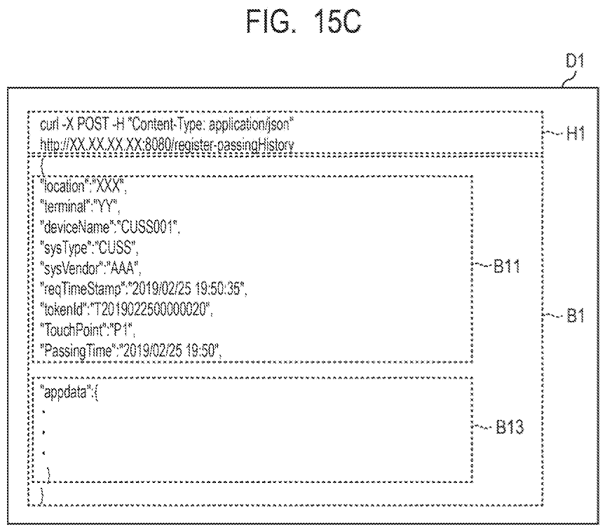

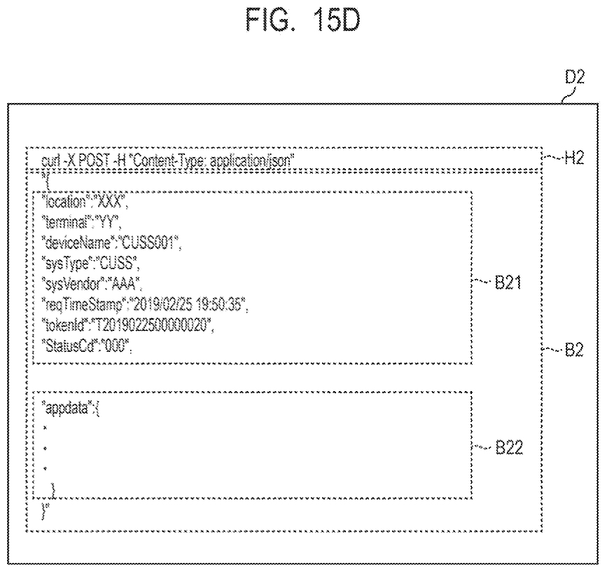

FIG. 15A is a diagram illustrating an example of the request data D1 transmitted to the management server 10 by the check-in terminal 20. The request data D1 is formed of the header part H1 and the body part B1. In the header part H1, a command indicating a token ID issuance request (“Issue-tokenId”) is written at the end of the URL.

Further, the body part B1 is formed of the control data B11, the face authenticating data B12, and the operation data B13. In the control data B11, label information and data on each item of a location of a terminal in the airport A (“location”), a terminal (“terminal”), a device name (“deviceName”), a system type (“sysType”), information on a system vender (“sysVender”), request data transmission time (“reqTimeStamp”), a camera ID used for face image capturing (“cameraId”), and a camera model name (“cameraModel”) are written.

Further, in the face authenticating data B12, label information and data on each item of a file name of a passport face image (“PassportFaceImage”), a capturing time of a captured face image (“queryTimeStamp”), a file name of a captured face image (“queryFaceImage”) are written.

Further, the operation data B13 is provided with a single label (“appdata”), and label information and data on each data item of operation data are hierarchically written in a portion bracketed between a symbol indicating a start part (“{”) and a symbol indicating an end part (“}”).

In response to receiving the request data D1 from the check-in terminal 20, the management server 10 matches the target face image captured by the check-in terminal 20 with the passport face image of the user U on a one-to-one basis (step S107). That is, in the example of FIG. 15A, a captured face image of a file name (“Q201902250000025.jpg”) and a passport face image of a file name (“P20190225000001.jpg”) are matched with each other.

Next, if the management server 10 determines that the result of matching of the target face image with the passport face image is that the matching is successful (step S108, YES), the management server 10 issues a token ID (step S109). The token ID is set to a unique value based on date and time of processing or a sequence number, for example.

Next, the management server 10 registers the relationship between the token ID and the registered face image to the token ID information DB 11 by using the target face image as the registered face image (step S110).

In the present example embodiment, the reason why a face image captured on site (a target face image) is used as a registered face image is that the validated period (lifecycle) of a token ID expires within the day, that a captured image is of closer quality (appearance) to an image captured in a subsequent authentication process than a passport face image, or the like. However, instead of a captured face image, a passport face image may be set as a registered face image (registered biometric information). For example, when the lifecycle of a token ID is long (for example, when a token ID is validated for a certain validated period for a membership in the airline business or the like), a face image of a passport or a license can be set as a registered face image.

Next, the management server 10 uses passport information and boarding reservation information as operation information to register the relationship between the token ID and the operation information to the operation information DB 13 (step S111). In such a way, while control data required for face authentication and operation information required for performing operation are managed in separate databases, a registered face image and the operation information are associated with each other by a token ID. In the example of FIG. 15A, a plurality of data items stored in the operation data B13 (passenger name (“PassengerName”), a passport number (“PassportNum”), a nationality (“Nationality”), a date of birth (“DateofBirth”), a sexuality (“Sex”), or the like) are registered as operation information in the operation information DB 13.

Next, the management server 10 transmits the response data D2 including the issued token ID and matching result information indicating a successful matching to the check-in terminal 20 (step S112).

FIG. 15B is a diagram illustrating an example of the response data D2 transmitted to the check-in terminal 20 by the management server 10. The response data D2 is formed of the header part H2 and the body part B2. Unlike the request data D1, the response data D2 does not include face authenticating data. Further, unlike the case of the control data B11 illustrated in FIG. 15A, label information and data on each data item of the issued token ID (“tokenId”) and a processing code indicating the processing status (“StatusCd”) are written. Herein, the issued token ID is “T2019022500000020”, and the processing code is “000” indicating a normal completion. In the operation data B22, label information and data on the same data items as those of the operation data B13 illustrated in FIG. 15A are written.

On the other hand, if the management server 10 determines that the result of matching of the passport face image with the target face image is that the matching failed (step S108, NO), the management server 10 transmits the response data D2 including matching result information indicating the failed matching to the check-in terminal 20 (step S113).

Next, if the check-in terminal 20 references the response data D2 received from the management server 10 and determines that it is possible to perform a check-in procedure (step S114, YES), the check-in terminal 20 performs a check-in procedure such as confirmation of an itinerary, a selection of a seat, or the like based on input information from the user U (step S115). The check-in terminal 20 then transmits the request data D1 that requests registration of passage history information on the user U to the management server 10 (step S116).

FIG. 15C is a diagram illustrating an example of the request data D1 transmitted to the management server 10 by the check-in terminal 20. Herein, in the header part H1, a command to request registration of passage history information on the user U (“register-passingHistory”) is written at the end of the URL. In the control data B11, label information and data on each item of a passing touch point (“TouchPoint”), a passing time (“PassingTime”), and the like are included. Further, in the example of FIG. 15C, it is indicated that no data is required to be written in the operation data B13. That is, data stored as the operation data B13 varies in accordance with the content of a command.

Next, in response to receiving the request data D1 from the check-in terminal 20, the management server 10 registers passage history information indicating the relationship between the token ID and passage information on the touch point P1 to the passage history information DB 12 (step S117).

The management server 10 then transmits the response data D2 to the check-in terminal 20 (step S118) and ends the process.

FIG. 15D is a diagram illustrating an example of the response data D2 transmitted to the check-in terminal 20 by the management server 10. Herein, label information and data on the issued token ID (“tokenId”) and a processing code indicating the status of the process (“StatusCd”) are written. The token ID is “T2019022500000020”, which is the same as that in FIG. 15B. Further, the processing code is “000” indicating a normal completion. That is, it is indicated that the registration process to the passage history information DB 12 was successful.

On the other hand, if the check-in terminal 20 references the response data D2 received from the management server 10 and determines that it is not possible to perform a check-in procedure on the user U (step S114, NO), the check-in terminal 20 notifies the user U of an error message (step S119). For example, a notification screen including a message such as “Please perform a check-in procedure at the manned counter” is displayed on the display device 207.

In such a way, a target face image (captured face image) successfully matched with a passport face image acquired from a passport in a check-in procedure is registered to the token ID information DB 11 as a registered face image, and a registered face image and operation information of the operation information DB 13 are associated with each other by the issued token ID. This enables a matching process between the captured face image and the registered face image to be made at each subsequent touch point. That is, the token ID associated with the registered face image is identification information that can be commonly used at all the touch points. The use of such a commonized token ID can increase efficiency of inspection on the user U.

### [Baggage Check-In Procedure]

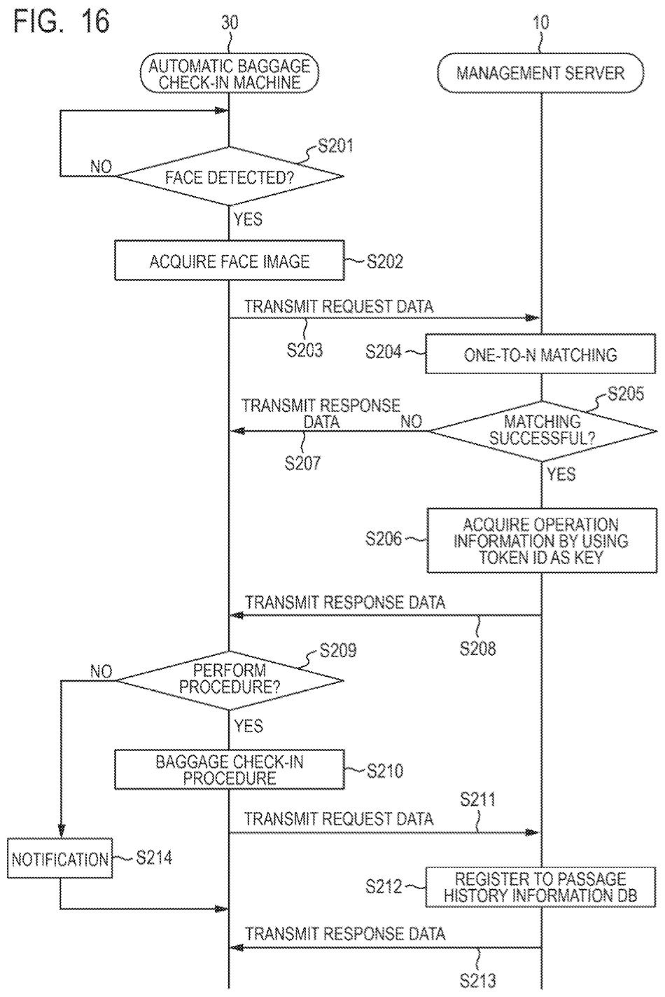

FIG. 16 is a sequence diagram illustrating an example of the process of the automatic baggage check-in machine 30 and the management server 10. This process is performed when the user U who completed a check-in procedure is subjected to a baggage check-in procedure as needed.

The automatic baggage check-in machine 30 captures an image of an area in front of the machine continually or periodically and determines whether or not a face of the user U standing in front of the automatic baggage check-in machine 30 is detected in the captured image (step S201). The automatic baggage check-in machine 30 stands by until a face of the user U is detected in an image by the biometric information acquisition device 309 (step S201, NO).

If the automatic baggage check-in machine 30 determines that a face of the user U is detected by the biometric information acquisition device 309 (step S201, YES), the automatic baggage check-in machine 30 captures the face of the user U and acquires a face image of the user U as a target face image (step S202).

Next, the automatic baggage check-in machine 30 transmits the request data D1 that requests execution of a matching process between the target face image and the registered face image to the management server 10 (step S203).

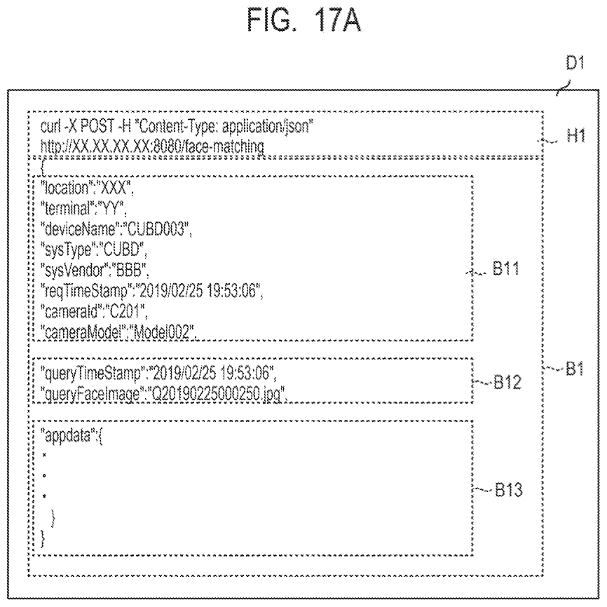

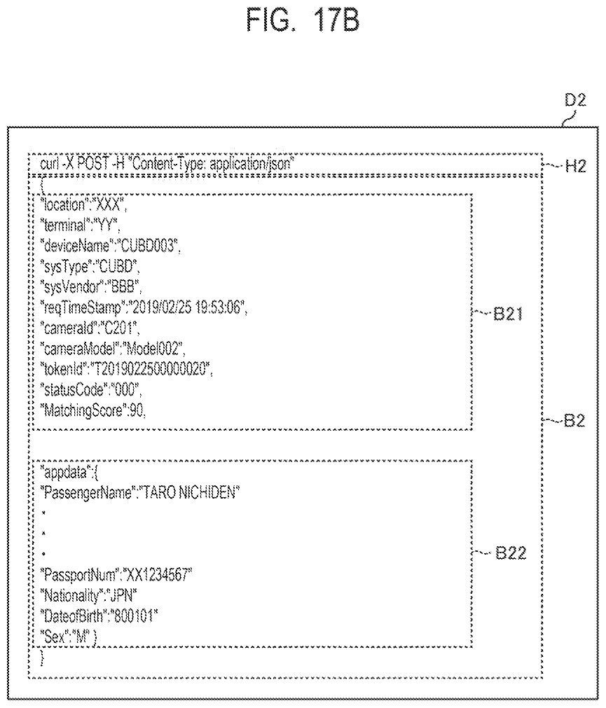

FIG. 17A is a diagram illustrating an example of the request data D1 transmitted to the management server 10 by the automatic baggage check-in machine 30. The request data D1 is formed of the header part H1 and the body part B1. In the header part H1, a command to request execution of a matching process (“face-matching”) is written at the end of the URL. Further, in the control data B11, label information and data indicating a device name of a source terminal of the request data D1 (“deviceName”), an operation system type (“sysType”), and the like are written.

Further, in the face authenticating data B12, label information and data on each item of a capturing time of a captured face image (“queryTimeStamp”) and a file name of a captured face image (“queryFaceImage”) are written. When the command is a matching request, unlike the example of FIG. 15A, a file name of a passport face image (“PassportFaceImage”) is omitted.

In response to receiving the request data D1 from the automatic baggage check-in machine 30, the management server 10 performs matching of a face image of the user U (step S204). That is, the management server 10 matches the target face image included in the request data D1 received from the automatic baggage check-in machine 30 with a plurality of registered face images registered in the token ID information DB 11 on a one-to-N basis. Note that the registered face images to be matched are limited to images associated with a token ID whose invalidation flag value is “1” (valid).

Herein, if the management server 10 determines that the result of matching is that the matching failed (step S205, NO), the management server 10 transmits the response data D2 including failed matching result information to the automatic baggage check-in machine 30 (step S207), and the process proceeds to step S209. In contrast, if the management server 10 determines that the result of matching is that the matching is successful (step S205, YES), the process proceeds to step S206.

In step S206, the management server 10 acquires operation information from the operation information DB 13 by using, as a key, the token ID associated with the successfully matched registered face image in the token ID information DB 11. The management server 10 then transmits the response data D2 to the automatic baggage check-in machine 30 (step S208).

FIG. 17B is a diagram illustrating an example of the response data D2 transmitted to the automatic baggage check-in machine 30 by the management server 10. Herein, label information and data on each item of a token ID associated with a registered face image (“tokenId”), a processing code (“StatusCd”), and a matching score (“MatchingScore”) are written. The token ID is “T2019022500000020”, which is found to be of the same person as in the example of FIG. 15D. Further, the processing code is “000” indicating a normal completion. That is, it is indicated that the result of matching of the target face image indicated in FIG. 17A (“queryFaceImage”: “Q20190225000250.jpg”) with the registered face image is that the matching is successful.

Further, in the operation data B22, operation information (a passenger name (“PassengerName”), a passport number (“PassportNum”), a nationality (“Nationality”), a date of birth (“DateofBirth”), a sexuality (“Sex”), or the like) acquired from the operation information DB 13 based on the token ID is written.

Next, if the automatic baggage check-in machine 30 references the response data D2 and determines that it is possible to perform the procedure (step S209, YES), the automatic baggage check-in machine 30 performs a process of a baggage check-in procedure on the user U (step S210).

Next, the automatic baggage check-in machine 30 transmits the request data D1 that requests registration of passage history information on the user U to the management server 10 (step S211).

In response to receiving the request data D1 from the automatic baggage check-in machine 30, the management server 10 registers passage history information indicating the relationship between the token ID and passage information on the user U at the touch point P2 to the passage history information DB 12 (step S212).

The management server 10 then transmits the response data D2 to the automatic baggage check-in machine 30 (step S213) and ends the process.

On the other hand, if the automatic baggage check-in machine 30 references the response data D2 and determines that it is not possible to perform the procedure (step S209, NO), the automatic baggage check-in machine 30 notifies the user U of an error message (step S214). For example, a notification screen including a message such as “Please check in your baggage at the manned counter.” is displayed on the display device 307.

### [Security Inspection Procedure]

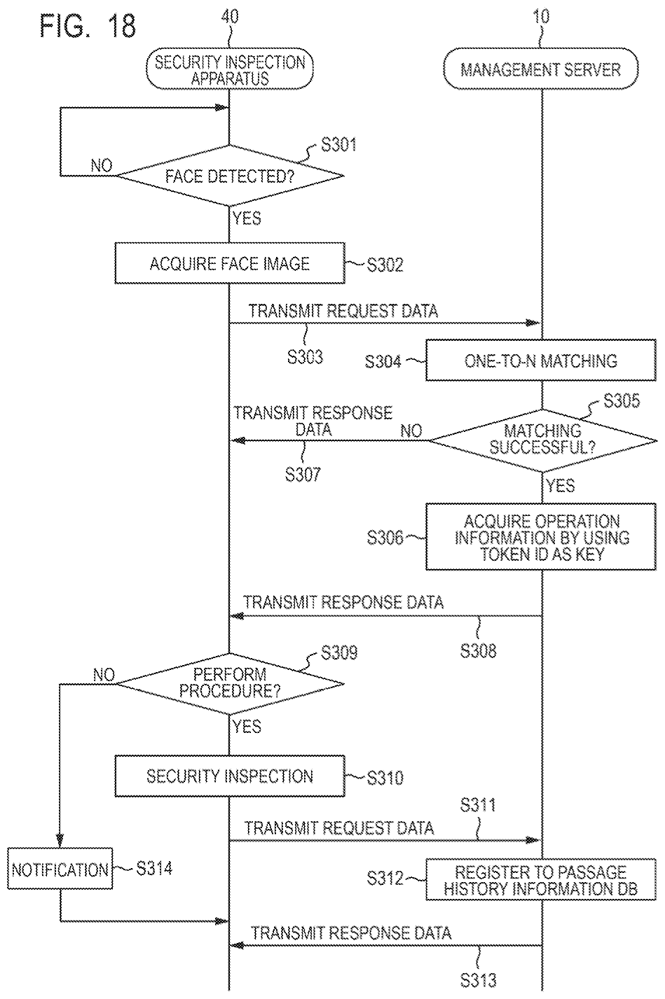

FIG. 18 is a sequence diagram illustrating an example of the process of the security inspection apparatus 40 and the management server 10. This process is performed when the user U who completed a check-in procedure is subjected to a security inspection procedure.

The security inspection apparatus 40 captures an image of an area in front of the entrance of the security inspection site continually or periodically and determines whether or not a face of the user U standing in front of the entrance is detected in the captured image (step S301). The security inspection apparatus 40 stands by until a face of the user U is detected in an image by the biometric information acquisition device 409 (step S301, NO).

If the security inspection apparatus 40 determines that a face of the user U is detected by the biometric information acquisition device 409 (step S301, YES), the security inspection apparatus 40 captures the face of the user U and acquires a face image of the user U as a target face image (step S302).

Next, the security inspection apparatus 40 transmits the request data D1 that requests execution of a matching process between the target face image and the registered face image to the management server 10 (step S303).

In response to receiving the request data D1 from the security inspection apparatus 40, the management server 10 performs matching of a face image of the user U (step S304). That is, the management server 10 matches the target face image included in the request data D1 received from the security inspection apparatus 40 with a plurality of registered face images registered in the token ID information DB 11 on a one-to-N basis. Note that the registered face images to be matched are limited to images associated with a token ID whose invalidation flag value is “1” (valid).

Herein, if the management server 10 determines that the result of matching is that the matching failed (step S305, NO), the management server 10 transmits the response data D2 including the result of matching of the failed matching to the security inspection apparatus 40 (step S307), and the process proceeds to step S309. In contrast, if the management server 10 determines that the result of matching is that the matching is successful (step S305, YES), the process proceeds to step S306.

In step S306, the management server 10 acquires operation information from the operation information DB 13 by using, as a key, the token ID associated with the successfully matched registered face image in the token ID information DB 11. The management server 10 then transmits the response data D2 including the matching result information, the token ID, and the operation information to the security inspection apparatus 40 (step S308).

Next, if the security inspection apparatus 40 references the response data D2 and determines that it is possible to perform the procedure (step S309, YES), the security inspection apparatus 40 performs a security inspection process on the user U (step S310). In the security inspection process, the CPU 401 controls each component of the security inspection apparatus 40. Accordingly, the security inspection apparatus 40 detects a metal object worn by the user U passing through the metal detector gate 410. The user U who has passed through the metal detector gate 410 moves to the departure inspection site.

Next, the security inspection apparatus 40 transmits the request data D1 that requests registration of passage history information on the user U to the management server 10 (step S311).

In response to receiving the request data D1 from the security inspection apparatus 40, the management server 10 registers passage history information indicating the relationship between the token ID and passage information on the user U at the touch point P3 to the passage history information DB 12 (step S312).

The management server 10 then transmits the response data D2 to the security inspection apparatus 40 (step S313) and ends the process.

On the other hand, if the security inspection apparatus 40 references the response data D2 and determines that it is not possible to perform the procedure (step S309, NO), the security inspection apparatus 40 notifies the user U of an error message (step S314).

### [Departure Inspection Procedure]

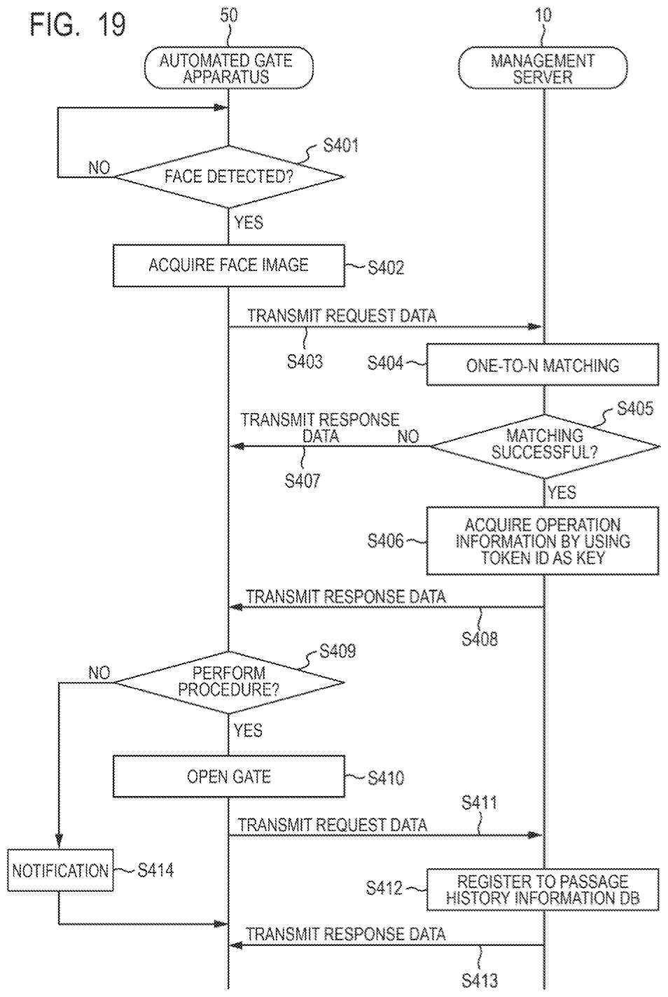

FIG. 19 is a sequence diagram illustrating an example of the process of the automated gate apparatus 50 and the management server 10. This process is performed when the user U who completed a security inspection procedure is subjected to a departure inspection procedure.

The automated gate apparatus 50 captures an image of an area in front of the automated gate apparatus 50 continually or periodically and determines whether or not a face of the user U standing in front of the automated gate apparatus 50 is detected in the captured image (step S401). The automated gate apparatus 50 stands by until a face of the user U is detected in an image by the biometric information acquisition device 509 (step S401, NO).

If the automated gate apparatus 50 determines that a face of the user U is detected by the biometric information acquisition device 509 (step S401, YES), the automated gate apparatus 50 captures the face of the user U and acquires a face image of the user U as a target face image (step S402).

Next, the automated gate apparatus 50 transmits the request data D1 that requests execution of a matching process between the target face image and the registered face image to the management server 10 (step S403).

In response to receiving the request data D1 from the automated gate apparatus 50, the management server 10 performs matching of a face image of the user U (step S404). That is, the management server 10 matches the target face image included in the request data D1 received from the automated gate apparatus 50 with a plurality of registered face images registered in the token ID information DB 11 on a one-to-N basis. Note that the registered face images to be matched are limited to images associated with a token ID whose invalidation flag value is “1” (valid).

Herein, if the management server 10 determines that the result of matching is that the matching failed (step S405, NO), the management server 10 transmits the response data D2 including matching result information indicating the failed matching to the automated gate apparatus 50 (step S407), and the process proceeds to step S409. In contrast, if the management server 10 determines that the result of matching is that the matching is successful (step S405, YES), the process proceeds to step S406.

In step S406, the management server 10 acquires operation information from the operation information DB 13 by using, as a key, the token ID associated with the successfully matched registered face image in the token ID information DB 11. The management server 10 then transmits the response data D2 including the matching result information, the token ID, and the operation information to the automated gate apparatus 50 (step S408).

Next, if the automated gate apparatus 50 references the response data D2 and determines that it is possible to perform the procedure (step S409, YES), the automated gate apparatus 50 performs a departure inspection procedure on the user U and opens the gate 511 (step S410). The user U who has passed through the touch point P4 moves to the departure area where a boarding gate is present.

Next, the automated gate apparatus 50 transmits the request data D1 that requests registration of passage history information on the user U to the management server 10 (step S411).

In response to receiving the request data D1 from the automated gate apparatus 50, the management server 10 registers passage history information indicating the relationship between the token ID and passage information on the user U at the touch point P4 to the passage history information DB 12 (step S412).

The management server 10 then transmits the response data D2 to the automated gate apparatus 50 (step S413) and ends the process.

On the other hand, if the automated gate apparatus 50 references the response data D2 and determines that it is not possible to perform the procedure (step S409, NO), the automated gate apparatus 50 notifies the user U of an error message (step S414). For example, a notification screen including a message such as “Please perform a departure inspection procedure at the manned counter.” is displayed on the display device 507.

### [Identity Verification Procedure at Boarding Gate]

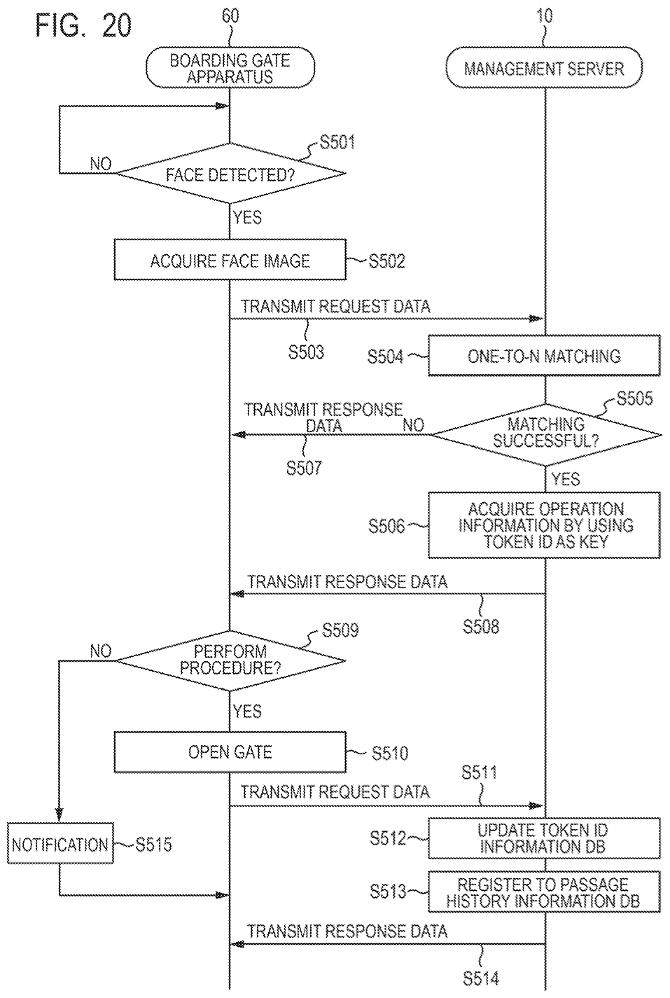

FIG. 20 is a sequence diagram illustrating an example of the process of the boarding gate apparatus 60 and the management server 10. This process is performed when the user U who completed a departure inspection procedure passes through a boarding gate in order to board an aircraft.

The boarding gate apparatus 60 captures an image of an area in front of the apparatus continually or periodically and determines whether or not a face of the user U standing in front of the boarding gate apparatus 60 is detected in the captured image (step S501). The boarding gate apparatus 60 stands by until a face of the user U is detected in an image by the biometric information acquisition device 609 (step S501, NO).

If the boarding gate apparatus 60 determines that a face of the user U is detected by the biometric information acquisition device 609 (step S501, YES), the boarding gate apparatus 60 captures the face of the user U and acquires a face image of the user U as a target face image (step S502).

Next, the boarding gate apparatus 60 transmits the request data D1 that requests execution of a matching process between the target face image and the registered face image to the management server 10 (step S503).

In response to receiving the request data D1 from the boarding gate apparatus 60, the management server 10 performs matching of a face image of the user U (step S504). That is, the management server 10 matches the target face image included in the request data D1 received from the boarding gate apparatus 60 with a plurality of registered face images registered in the token ID information DB 11 on a one-to-N basis. Note that the registered face images to be matched are limited to images associated with a token ID whose invalidation flag value is “1” (valid).

Herein, if the management server 10 determines that the result of matching is that the matching failed (step S505, NO), the management server 10 transmits the response data D2 including matching result information indicating the failed matching to the boarding gate apparatus 60 (step S507), and the process proceeds to step S509. In contrast, if the management server 10 determines that the result of matching is that the matching is successful (step S505, YES), the process proceeds to step S506.

In step S506, the management server 10 acquires operation information from the operation information DB 13 by using, as a key, the token ID associated with the successfully matched registered face image in the token ID information DB 11. The management server 10 then transmits the response data D2 including the matching result information, the token ID, and the operation information to the boarding gate apparatus 60 (step S508).

Next, if the boarding gate apparatus 60 references the response data D2 and determines that it is possible to perform the procedure (step S509, YES), the boarding gate apparatus 60 performs an aircraft boarding procedure on the user U and opens the gate 611 (step S510). The user U who has passed through the touch point P5 boards the aircraft.

Next, the boarding gate apparatus 60 transmits the request data D1 that requests invalidation of the token ID and registration of passage history information on the user U to the management server 10 (step S511).

In response to receiving the request data D1 from the boarding gate apparatus 60, the management server 10 updates the token ID information DB 11 (step S512). Specifically, the management server 10 updates the invalidation flag of the token ID information DB 11 to a value of invalid (“0”). Accordingly, the validated period (lifecycle) of the token ID expires.

Next, the management server 10 registers passage history information indicating the relationship between the token ID and passage information on the user U at the touch point P5 to the passage history information DB 12 (step S513).

The management server 10 then transmits the response data D2 to the boarding gate apparatus 60 (step S514) and ends the process.

On the other hand, if the boarding gate apparatus 60 references the response data D2 and determines that it is not possible to perform the procedure (step S509, NO), the boarding gate apparatus 60 notifies the user U of an error message (step S515). For example, the boarding gate apparatus 60 displays a notification screen including a message such as “Please perform the procedure at the manned counter.” on the display device 607.

As described above, according to the present example embodiment, a face authentication technology can be easily applied to a plurality of operations performed in the airport A. This increases efficiency of each operation. Further, although airport operations performed on the user U in departure from a country has been described in the present example embodiment, the configuration of the present example embodiment can also be applied to other operations such as an immigration inspection procedure in entry to a country, a custom procedure, or the like.

### Second Example Embodiment

An information processing system 2 in the present example embodiment will be described below. Note that references common to the references provided in the drawings of the first example embodiment represent the same object. The description of features common to the first example embodiment will be omitted, and different features will be described in detail.

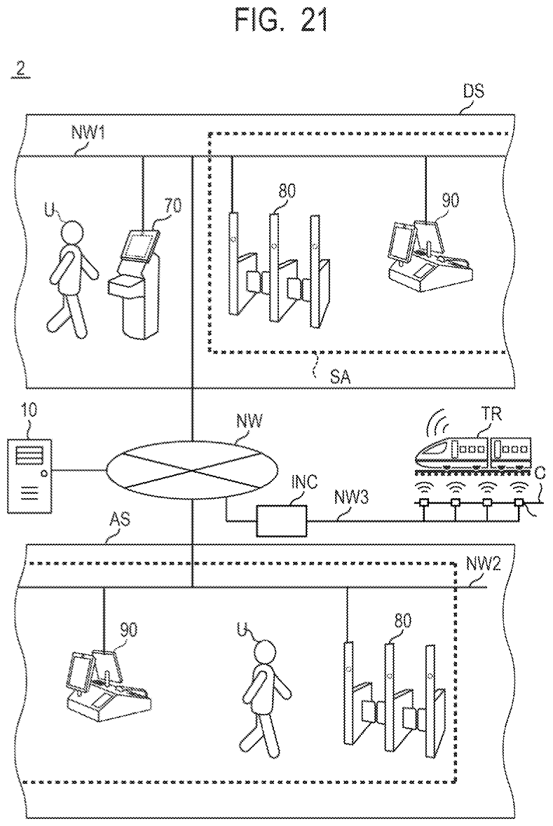

FIG. 21 is a schematic diagram illustrating an example of the overall configuration of the information processing system 2 in the present example embodiment. The information processing system 2 is a computer system that supports various operations related to a railroad. In FIG. 21, in the information processing system 2, an automatic ticket vending machine 70 that sells a train ticket, an automatic ticket gate 80 installed at a ticket gate of a security area SA of a station, a POS terminal 90 installed in the security area SA, and an Internet connection apparatus INC are connected to the management server 10 via networks NW, NW1, and NW2. The network NW1 is a network provided in a departure station DS, and the network NW2 is a network provided in an arrival station AS. A plurality of wireless communication devices RS are connected to the Internet connection apparatus INC via a network NW3. The plurality of wireless communication devices RS are installed on a coaxial cable C laid along rails and wirelessly communicate with a mobile communication station (not illustrated) in a train TR moving on the rails. This enables the management server 10 and the train TR to perform data communication with each other via the networks NW and NW3.

Further, the management server 10 in the present example embodiment has the token ID information DB 11, the passage history information DB 12, and the operation information DB 13 in the same manner as in the first example embodiment. However, since the operations in the present example embodiment differs from the operations of the first example embodiment, the data items of the operation information stored in the operation information DB 13 also differ. Specifically, the operation in the present example embodiment includes an operation involving commercial transactions in a station. Thus, the operation information includes payment information such as a credit card number. Note that the management server 10 and the automatic ticket gate 80 can control entry and exit of a user U based on face authentication even for the user U whose payment information is not registered.

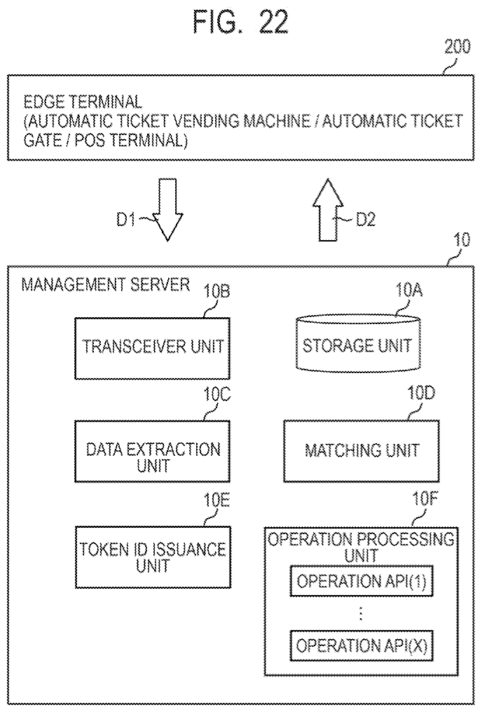

FIG. 22 is a function block diagram of the management server 10 in the present example embodiment. As illustrated in FIG. 22, the automatic ticket vending machine 70, the automatic ticket gate 80, and the POS terminal 90 correspond to the edge terminal 200 in the present example embodiment. While the configuration of the management server 10 is the same as that in the case of the first example embodiment, the function of the operation processing unit 10F (operation API) differs from that of the first example embodiment.

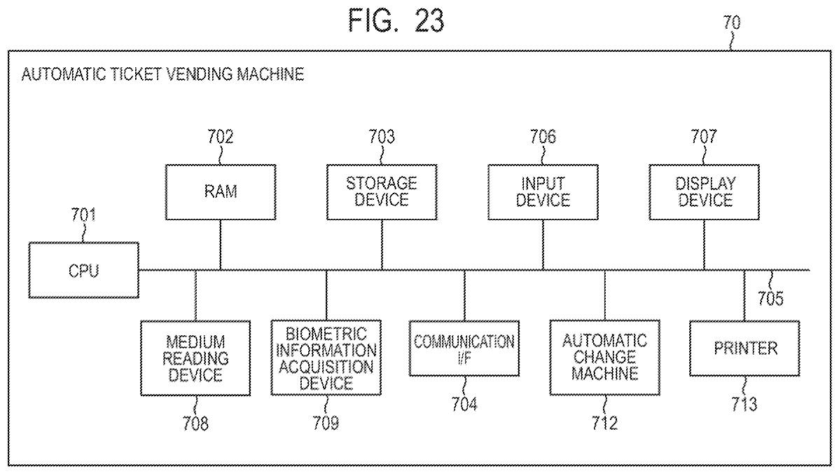

FIG. 23 is a block diagram illustrating an example of the hardware configuration of the automatic ticket vending machine 70. As illustrated in FIG. 23, the automatic ticket vending machine 70 has a CPU 701, a RAM 702, a storage device 703, a communication I/F 704, an input device 706, a display device 707, a medium reading device 708, a biometric information acquisition device 709, an automatic change machine 712, and a printer 713. Each device is connected to a bus line 705.

The automatic change machine 712 is an apparatus that, when a total amount of money put into a deposit slot exceeds a payment for purchasing an item or using a service, automatically discharges money in accordance with a change amount calculated by the CPU 701 to a dispensing port. The printer 713 prints a train ticket, a receipt, a credit card statement, or the like under the control of the CPU 701.

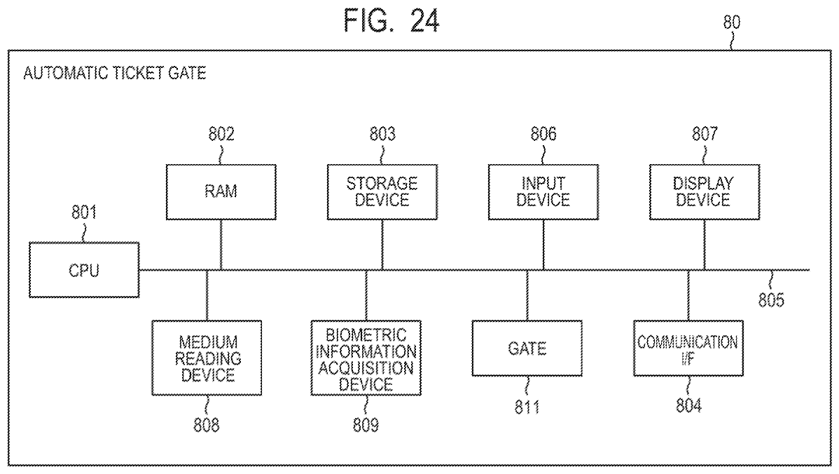

FIG. 24 is a block diagram illustrating an example of the hardware configuration of the automatic ticket gate 80. As illustrated in FIG. 24, the automatic ticket gate 80 has a CPU 801, a RAM 802, a storage device 803, a communication I/F 804, an input device 806, a display device 807, a medium reading device 808, a biometric information acquisition device 809, and a gate 811. Each device is connected to a bus line 805.

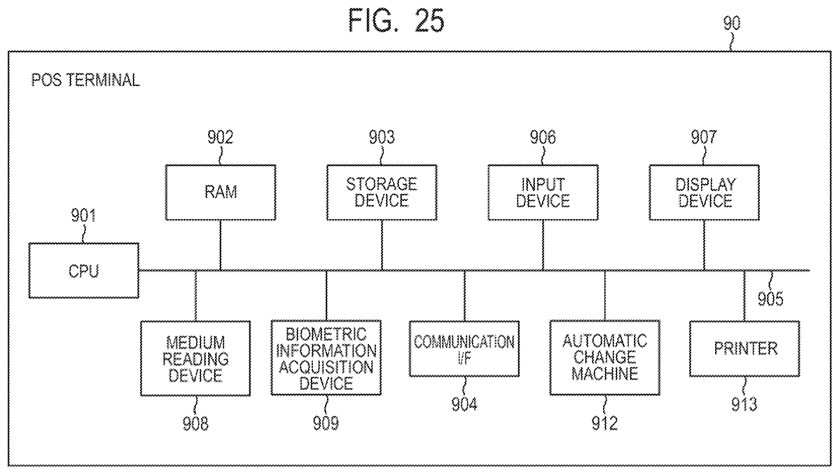

FIG. 25 is a block diagram illustrating an example of the hardware configuration of the POS terminal 90. The POS terminal 90 has a CPU 901, a RAM 902, a storage device 903, a communication I/F 904, an input device 906, a display device 907, a medium reading device 908, a biometric information acquisition device 909, an automatic change machine 912, and a printer 913. Each device is connected to a bus line 905.

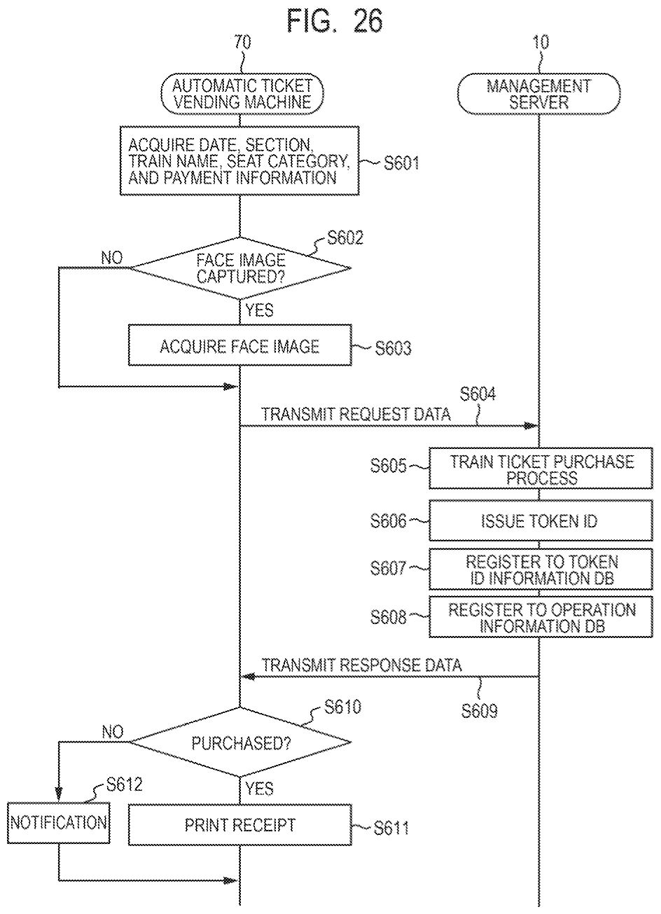

Subsequently, the operation of each device of the information processing system 2 in the present example embodiment will be described with reference to FIG. 26 to FIG. 35.

### [Token Issuance Process in Ticket Issuance]

FIG. 26 is a sequence diagram illustrating an example of the process of the automatic ticket vending machine 70 and the management server 10. This process is performed when the user U purchases a railroad train ticket from the automatic ticket vending machine 70.

First, the automatic ticket vending machine 70 acquires information related to a train ticket such as a date, a section, a train name, and a seat category and payment information for purchasing (step S601).

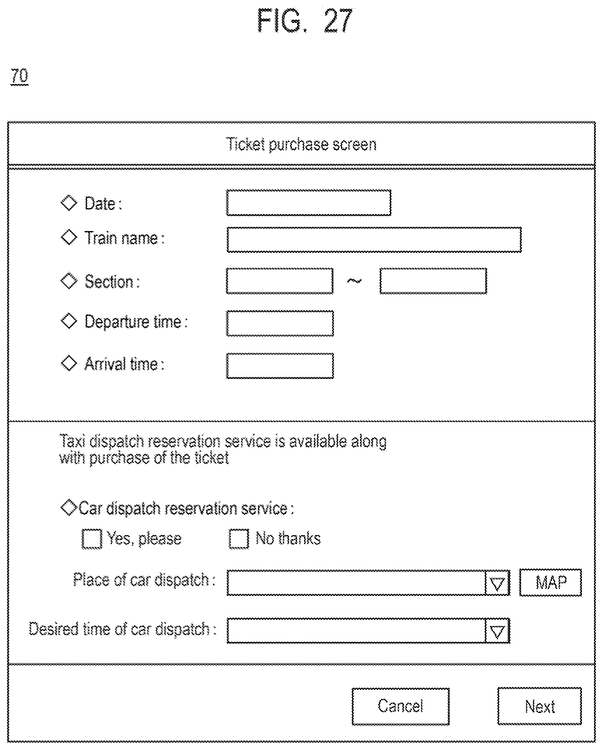

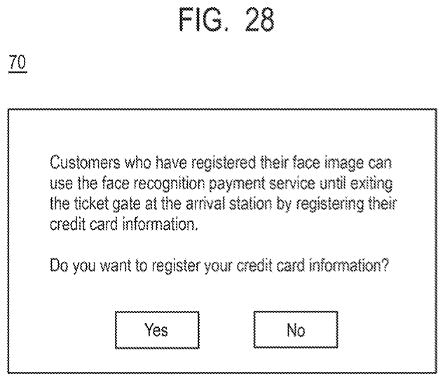

FIG. 27 and FIG. 28 are diagrams illustrating examples of a screen displayed on the automatic ticket vending machine 70. The upper field in the screen of FIG. 27 includes an entry form for a date, a train name, a section, a departure time, and an arrival time as conditions for searching for a train to be used. Further, the lower field in the screen of FIG. 27 includes an entry form used for specifying whether or not to use a taxi dispatch reservation service at an arrival station (alighting station) AS. Note that, in the case of FIG. 27, as the conditions for searching a train to be used, the automatic ticket vending machine 70 requests the user U to input a date, a train name, a section, a departure time, and an arrival time and then reserves and issues a train ticket. However, a method of reserving and issuing a train ticket is not limited thereto. For example, when the user U has registered his/her face image during online reservation made from his/her own terminal, it is possible to call reservation information on the user U by performing face authentication during issuance of a ticket by the automatic ticket vending machine 70. Further, the system configuration may be changed so that, when the user U has registered his/her face image during online reservation, the user U can pass through a touch point such as the automatic ticket gate 80 or the like without operating the automatic ticket vending machine 70 to issue a ticket. Furthermore, when the user U is a membership who has registered his/her face image on a server in advance, it is not required to register a face image every time purchasing a train ticket. This can improve convenience for the user U.

In FIG. 28, a guidance message related to a payment service using face authentication (“Customers who have registered their face image can use the face recognition payment service until exiting the ticket gate at the arrival station by registering their credit card information. Do you want to register your credit card information?”) and operation buttons (Yes/No) are displayed.

Next, the automatic ticket vending machine 70 determines whether or not there is a consent from the user U about face image capturing. Herein, if the automatic ticket vending machine 70 determines that there is a consent from the user U (step S602, YES), the automatic ticket vending machine 70 acquires a face image of the user U captured by the biometric information acquisition device 709 as a registered face image (step S603), and the process proceeds to step S604. In contrast, if the automatic ticket vending machine 70 determines that there is no consent from the user U (step S602, NO), the process proceeds to step S604.

In step S604, the request data D1 that requests purchasing of a train ticket and issuance of a token ID is transmitted to the management server 10. If a face image has been captured in step S603, the face image of the user U (registered face image) is included in the request data D1. Further, if a consent about registration of payment information has been obtained from the user U, it is preferable to include data of instruction for payment information registration in the request data D1.

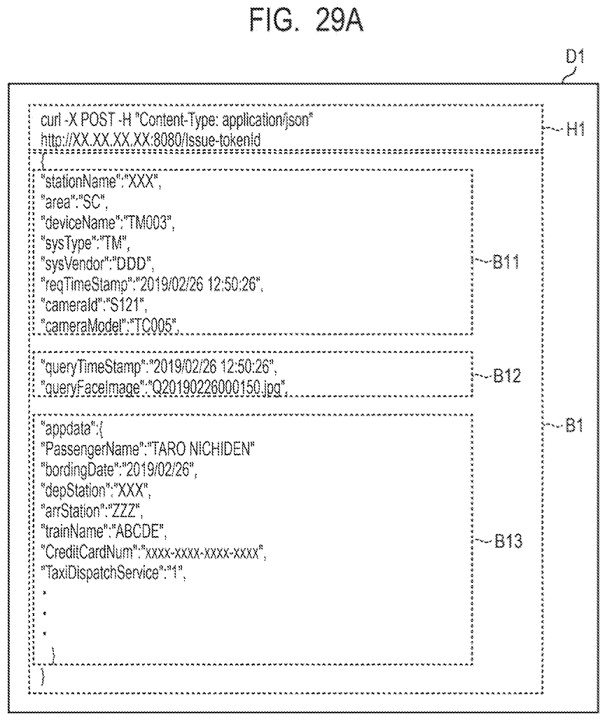

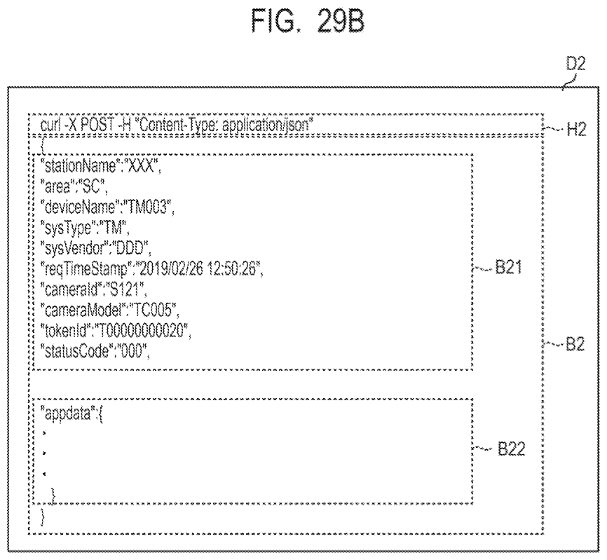

FIG. 29A is a diagram illustrating an example of the request data D1 transmitted to the management server 10 by the automatic ticket vending machine 70. The request data D1 is formed of the header part H1 and the body part B1. In the header part H1, a command indicating a token ID issuance request (“Issue-tokenId”) is written at the end of the URL.

In the control data B11, label information and data on each item of a station name (“stationName”), an installation area of the automatic ticket vending machine 70 (“area”), a device name (“deviceName”), a system type (“sysType”), information on a system vender (“sysVender”), a request data transmission time (“reqTimeStamp”), a camera ID used for capturing a face image (“cameraId”), and a camera model name (“cameraModel”) are written.

Further, in the face authenticating data B12, label information and data on each item of a capturing time of a captured face image (“queryTimeStamp”) and a file name of a captured face image (“queryFaceImage”) are written.

Further, the operation data B13 is provided with a single label (“appdata”), and label information and data on each data item of operation data are hierarchically written in a portion bracketed between a symbol indicating a start part (“{”) and a symbol indicating an end part (“}”). In the example of FIG. 29A, the operation data B13 includes label information and data on a name of the boarding user U (“PassengerName”), a boarding date (“boardingDate”), a departure station (“depStation”), an arrival station (“arrStation”), a train name to be used (“trainName”), a credit card number (“CreditCardNum”), a taxi dispatch reservation service (“TaxiDispatchService”), and the like. The data extraction unit 10C of the present example embodiment can assign operation data to two or more APIs based on one request data D1. Accordingly, it is possible to call the operation API for a car dispatch reservation service at the same time as purchasing a railroad train ticket and complete a car dispatch reservation in accordance with the arrival time of the train TR or the like.

In step S605, in response to receiving the request data D1 from the automatic ticket vending machine 70, the management server 10 performs a train ticket purchasing process. The management server 10 then issues a token ID (step S606). Next, the management server 10 registers the relationship between the token ID and the registered face image to the token ID information DB 11 (step S607).

Next, the management server 10 registers the relationship between the token ID and operation information (the operation data B13 of FIG. 29A) to the operation information DB 13 (step S608). Accordingly, the registered face image and the operation information such as payment information are associated with each other by the token ID.

Next, the management server 10 transmits the response data D2 including the issued token ID to the automatic ticket vending machine 70 (step S609).

FIG. 29B is a diagram illustrating an example of the response data D2 transmitted to the automatic ticket vending machine 70 by the management server 10. Further, unlike the control data B11 illustrated in FIG. 29A, in the control data B21, label information and data on each data item of the token ID (“tokenId”) issued to the user U and a processing code indicating the processing status (“StatusCd”) are written. Herein, the issued token ID is “T00000000020”, and the processing code is “000” indicating a normal completion.

In step S610, the automatic ticket vending machine 70 references the response data D2 and determines whether or not the user U successfully purchased a train ticket. Herein, if the automatic ticket vending machine 70 determines that the user U successfully purchased a train ticket (step S610, YES), the automatic ticket vending machine 70 prints a receipt (step S611) and ends the process. Note that, instead of a receipt, a paper train ticket may be printed.

On the other hand, if the automatic ticket vending machine 70 references the response data D2 and determines that the user U failed to purchase a train ticket (step S610, NO), the automatic ticket vending machine 70 notifies that the purchasing process failed (step S612).

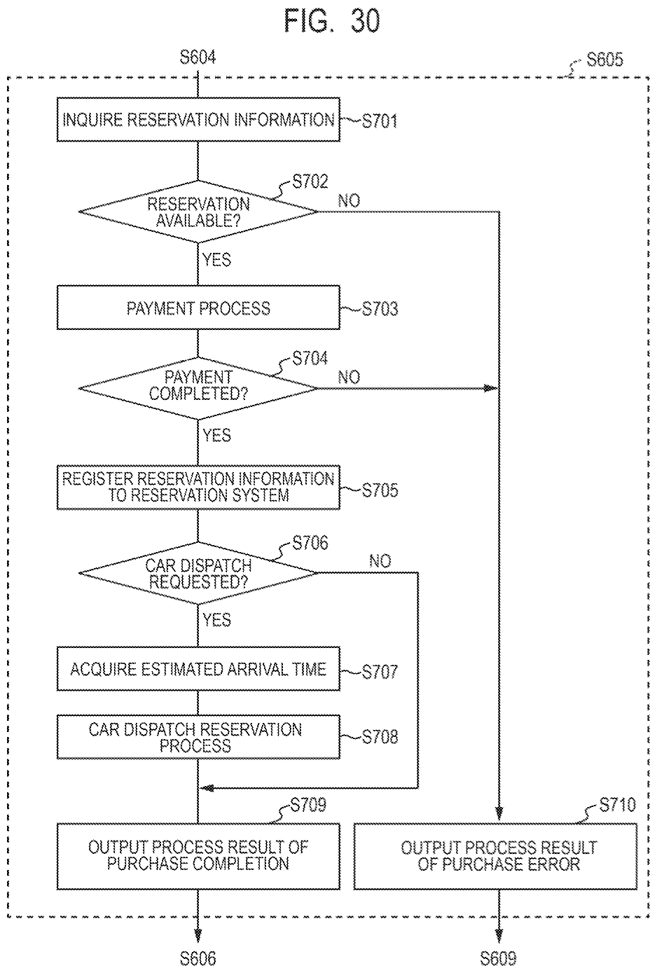

FIG. 30 is a flowchart illustrating an example of the process of the management server 10. This process corresponds to step S605 of FIG. 26.

First, the management server 10 queries reservation information stored in a reservation database (not illustrated) based on conditions specified by the user U (step S701).

Next, the management server 10 determines based on a query result whether or not a boarding reservation is available (step S702). Herein, if the management server 10 determines that the boarding reservation is available (step S702, YES), the management server 10 performs a payment process based on payment information (step S703), and the process proceeds to step S704. In contrast, if the management server 10 determines that the boarding reservation is unavailable (step S702, NO), the process proceeds to step S710.

In step S704, the management server 10 determines whether or not the payment process is normally completed. Herein, if the management server 10 determines that the payment process is normally completed (step S704, YES), the management server 10 registers reservation information to the reservation system (step S705), and the process proceeds to step S706. In contrast, if the management server 10 determines that the payment process failed (step S704, NO), the process proceeds to step S710.

In step S706, the management server 10 determines whether or not car dispatch is requested. Herein, if the management server 10 determines that car dispatch is requested (step S706, YES), the management server 10 acquires an estimated arrival time at the arrival station AS of the train TR to be used (step S707) and performs a car dispatch reservation process (step S708). In the car dispatch reservation process, it is preferable to reflect a car dispatch place and a desired car dispatch time input by the user U (see FIG. 27). Note that, if an operation API of an external system (not illustrated) performs a car dispatch process, the operation processing unit 10F functions as an API for calling the external system.

In step S709, the management server 10 outputs a process result of a purchase completion, and the process proceeds to step S606 of FIG. 26. On the other hand, in step S710, the management server 10 outputs a process result of a purchase error, and the process proceeds to step S609 of FIG. 26.

### [Entry Process Using Face Authentication]

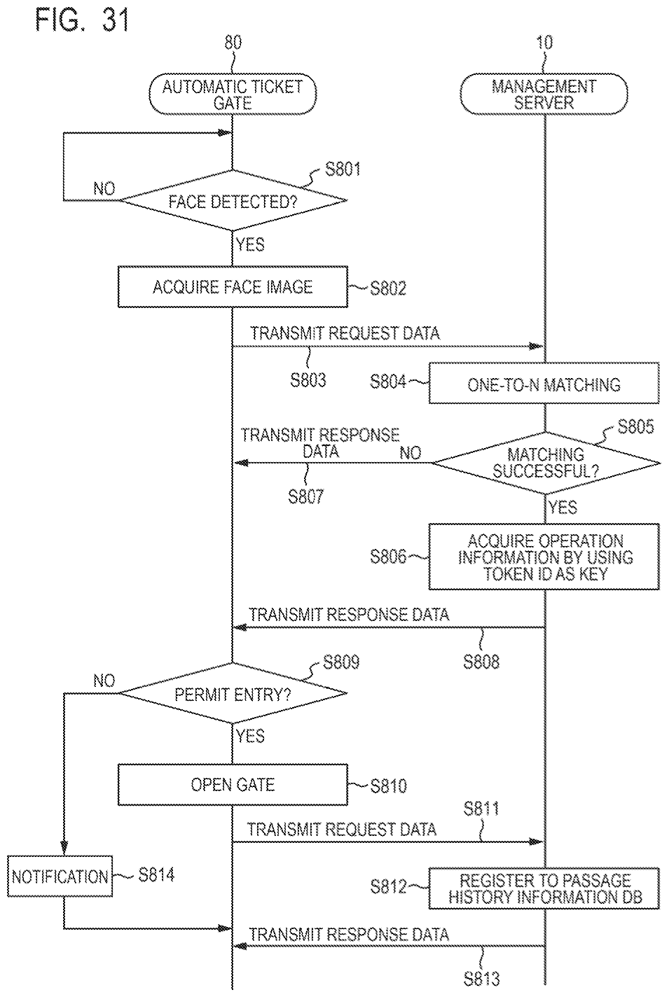

FIG. 31 is a sequence diagram illustrating an example of the process of the automatic ticket gate 80 and the management server 10. This process is performed when the user U who has registered his/her face image during purchase of a train ticket enters the site through a ticket gate.

The automatic ticket gate 80 captures an image of an area in front of the automatic ticket gate 80 continually or periodically and determines whether or not a face of the user U standing in front of the automatic ticket gate 80 is detected in the captured image (step S801). The automatic ticket gate 80 stands by until a face of the user U is detected in an image by the biometric information acquisition device 809 (step S801, NO).

If the automatic ticket gate 80 determines that a face of the user U is detected by the biometric information acquisition device 809 (step S801, YES), the automatic ticket gate 80 captures the face of the user U and acquires a face image of the user U as a target face image (step S802).

Next, the automatic ticket gate 80 transmits the request data D1 that requests execution of a matching process between the target face image and the registered face image to the management server 10 (step S803).

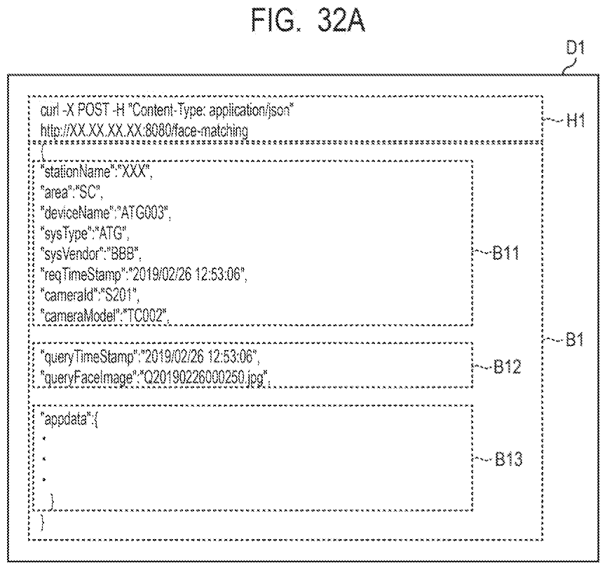

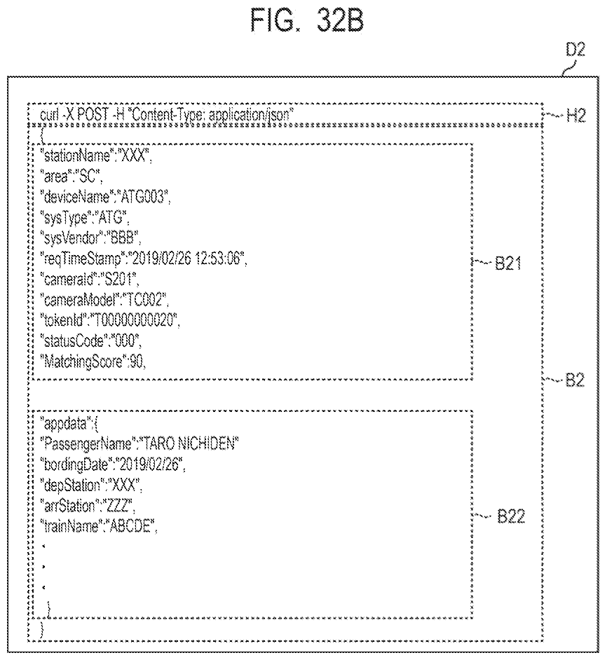

FIG. 32A is a diagram illustrating an example of the request data D1 transmitted to the management server 10 by the automatic ticket gate 80. The request data D1 is formed of the header part H1 and the body part B1. In the header part H1, a command that requests execution of a matching process (“face-matching”) is written at the end of the URL. Further, in the control data B11, label information and data on each item of a device name of a source terminal of the request data D1 (“deviceName”) and an operation system type (“sysType”) are written.

Further, in the face authenticating data B12, label information and data on each item of a capturing time of a captured face image (“queryTimeStamp”) and a file name of a captured face image (“queryFaceImage”) are written.

In response to receiving the request data D1 from the automatic ticket gate 80, the management server 10 performs matching of a face image of the user U (step S804). That is, the management server 10 matches the target face image included in the request data D1 received from the automatic ticket gate 80 with a plurality of registered face images registered in the token ID information DB 11 on a one-to-N basis. Note that the registered face images to be matched are limited to images associated with a token ID whose invalidation flag value is “1” (valid).

Herein, if the management server 10 determines that the result of matching is that the matching failed (step S805, NO), the management server 10 transmits the response data D2 including matching result information indicating the failed matching to the automatic ticket gate 80 (step S807), and the process proceeds to step S809. In contrast, if the management server 10 determines that the result of matching is that the matching is successful (step S805, YES), the process proceeds to step S806.

In step S806, the management server 10 acquires operation information from the operation information DB 13 by using, as a key, the token ID associated with the successfully matched registered face image in the token ID information DB 11. The management server 10 then transmits the response data D2 including the matching result information, the token ID, and the operation information to the automatic ticket gate 80 (step S808).

FIG. 32B is a diagram illustrating an example of the response data D2 transmitted to the automatic ticket gate 80 by the management server 10. Herein, label information and data on each item of a token ID associated with a registered face image (“tokenId”), a processing code (“StatusCd”), and a matching score (“MatchingScore”) are written. The token ID is “T00000000020”, which is found to be of the same person as the person who purchased the train ticket (see FIG. 29B). Further, the processing code is “000” indicating a normal completion. That is, it is indicated that the result of matching of the target face image indicated in FIG. 32A (“queryFaceImage”: “Q20190226000250.jpg”) with the registered face image is that the matching is successful.

Next, if the automatic ticket gate 80 references the response data D2 and determines that it is possible to permit entry (step S809, YES), the automatic ticket gate 80 opens the gate 811 (step S810). The user U who has passed the ticket gate moves to a predetermined place in order to board the train TR.

Next, the automatic ticket gate 80 transmits the request data D1 that requests registration of passage history information on the user U to the management server 10 (step S811).

In response to receiving the request data D1 from the automatic ticket gate 80, the management server 10 registers passage history information indicating the relationship between the token ID and passage information on the user U to the passage history information DB 12 (step S812).

The management server 10 then transmits the response data D2 to the automatic ticket gate 80 (step S813) and ends the process.

On the other hand, if the automatic ticket gate 80 references the response data D2 and determines that it is not possible to permit entry (step S809, NO), the automatic ticket gate 80 notifies the user U of an error message (step S814). For example, a notification screen including a message such as “Please contact the station staff nearby.” is displayed on the display device 807.

### [Payment Process Using Face Authentication]

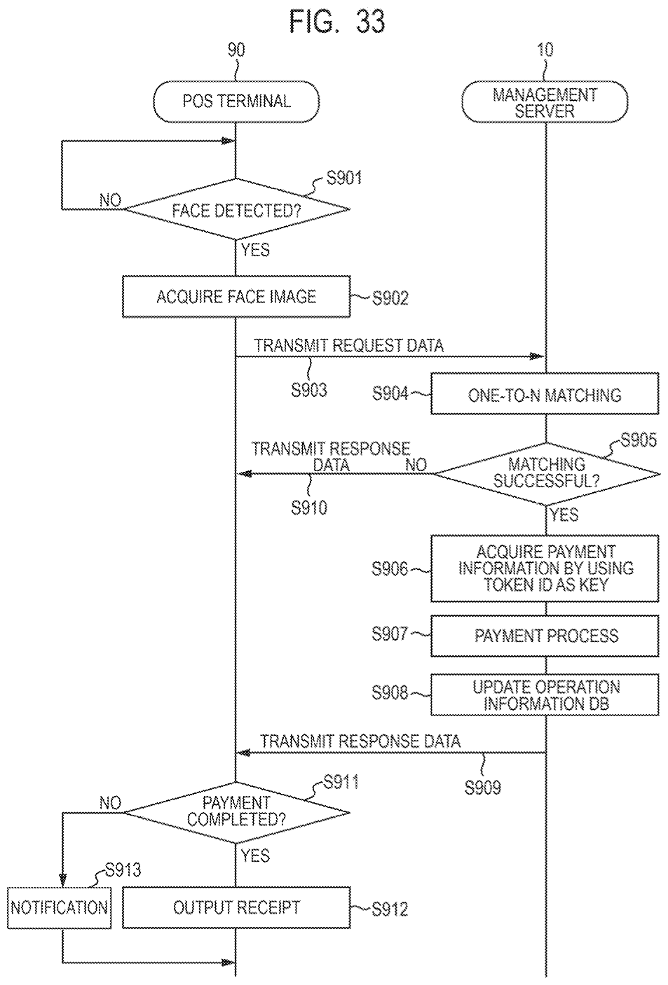

FIG. 33 is a sequence diagram illustrating an example of the process of the POS terminal 90 and the management server 10. This process is performed when a payment method using face authentication is specified by the user U during purchase of an item inside a station (inside a ticket gate) or inside the train TR, for example.

First, when start of a payment process is instructed by staff, the POS terminal 90 determines whether or not a face of the user U standing in front of the POS terminal 90 is detected in an image capturing an area in front of the device (step S901). The POS terminal 90 stands by until a face of the user U is detected in an image by the biometric information acquisition device 909 (step S901, NO).

If the POS terminal 90 determines that a face of the user U is detected by the biometric information acquisition device 909 (step S901, YES), the POS terminal 90 captures the face of the user U and acquires a face image of the user U as a target face image (step S902).

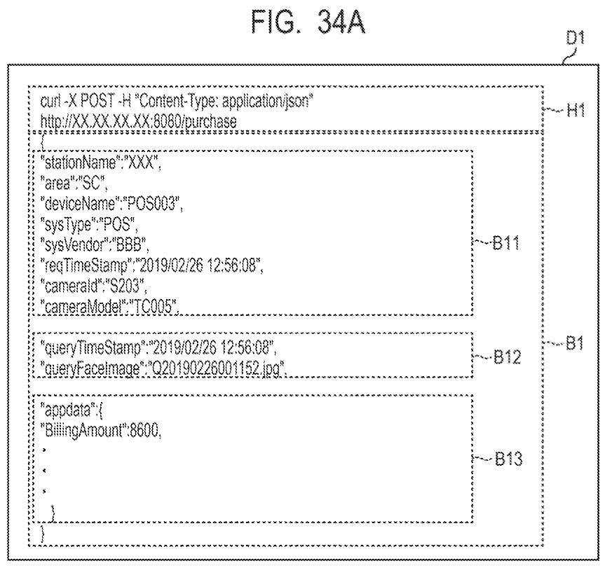

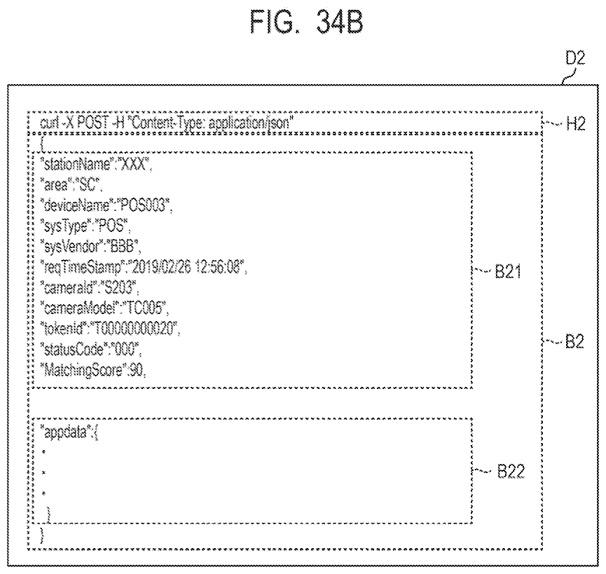

Next, the POS terminal 90 transmits the request data D1 that requests execution of a matching process between the target face image and the registered face image and execution of a payment process to the management server 10 (step S903). FIG. 34A is a diagram illustrating an example of the request data D1 transmitted to the management server 10 by the POS terminal 90. The request data D1 is formed of the header part H1 and the body part B1. In the header part H1, a command indicating a payment process execution request (“purchase”) is written at the end of the URL. Further, in the operation data B13 of the body part B1, label information and data on a billing amount (“BillingAmount”) are written.

In response to receiving the request data D1 from the POS terminal 90, the management server 10 performs matching of a face image of the user U (step S904). That is, the management server 10 matches the target face image included in the request data D1 received from the POS terminal 90 with a plurality of registered face images registered in the token ID information DB 11 on a one-to-N basis. Note that the registered face images to be matched are limited to images associated with a token ID whose invalidation flag value is “1” (valid).

Herein, if the management server 10 determines that the result of matching is that the matching failed (step S905, NO), the management server 10 transmits the response data D2 including matching result information indicating the failed matching to the POS terminal 90 (step S910), and the process proceeds to step S911. In contrast, if the management server 10 determines that the result of matching is that the matching is successful (step S905, YES), the process proceeds to step S906.

In step S906, the management server 10 acquires payment information included in operation information from the operation information DB 13 by using, as a key, the token ID associated with the successfully matched registered face image.

Next, the management server 10 performs a payment process based on the payment information (step S907) and then updates the operation information DB 13 based on the token ID, information on the purchased item, and the like (step S908).

The management server 10 then transmits the response data D2 including the result of matching, the token ID, and a payment result to the POS terminal 90 (step S909), and the process then proceeds to step S911.

FIG. 34B is a diagram illustrating an example of the response data D2 transmitted to the POS terminal 90 by the management server 10. Further, unlike the case of the control data B11 illustrated in FIG. 34A, in the control data B21, label information and data on each data item of the token ID issued to the user U (“tokenId”), a processing code indicating the process status (“StatusCd”), and a matching score (“MatchingScore”) are written.

In step S911, the POS terminal 90 references the response data D2 and determines whether or not the payment process is normally completed. Herein, if the POS terminal 90 determines that the payment process is normally completed (step S911, YES), the POS terminal 90 prints a receipt (step S912) and ends the process.

On the other hand, if the POS terminal 90 determines that it is not possible to perform the payment process based on the payment information (step S911, NO), the POS terminal 90 notifies the user U of an error message (step S913).

As described above, a face image and payment information are associated with each other by a token ID when a train ticket is purchased, and thereby a payment process using face authentication is made possible in a period in which the token ID is valid.

### [Exit Process Using Face Authentication]

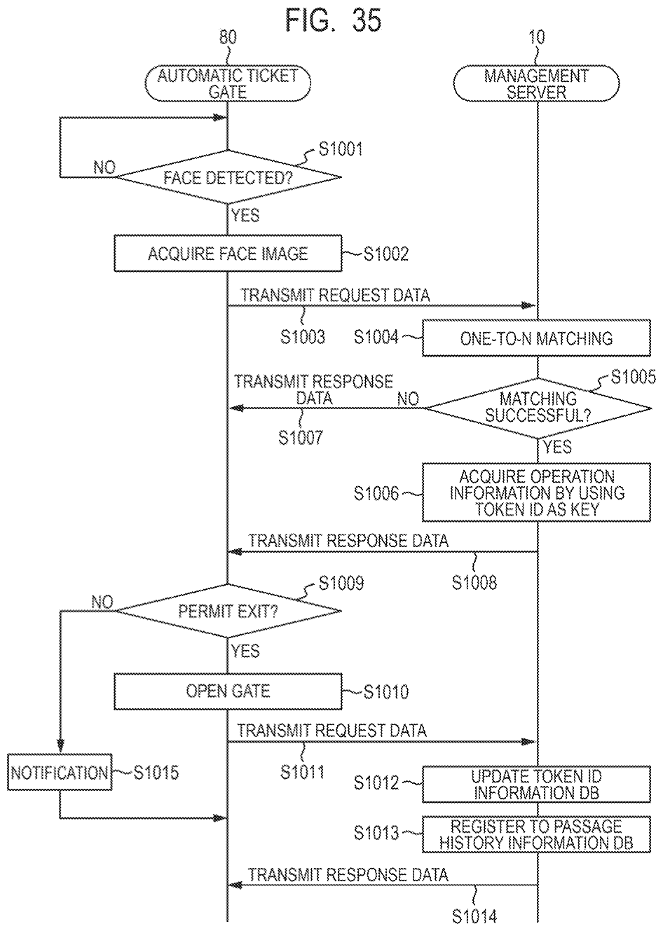

FIG. 35 is a sequence diagram illustrating an example of the process of the automatic ticket gate 80 and the management server 10. This process is performed when the user U passes through a ticket gate of an arrival station.

The automatic ticket gate 80 captures an image of an area in front of the automatic ticket gate 80 continually or periodically and determines whether or not a face of the user U standing in front of the automatic ticket gate 80 is detected in the captured image (step S1001). The automatic ticket gate 80 stands by until a face of the user U is detected in an image by the biometric information acquisition device 809 (step S1001, NO).

If the automatic ticket gate 80 determines that a face of the user U is detected by the biometric information acquisition device 809 (step S1001, YES), the automatic ticket gate 80 captures the face of the user U and acquires a face image of the user U as a target face image (step S1002).

Next, the automatic ticket gate 80 transmits the request data D1 that requests execution of a matching process between the target face image and the registered face image to the management server 10 (step S1003).

In response to receiving the request data D1 from the automatic ticket gate 80, the management server 10 performs matching of a face image of the user U (step S1004). That is, the management server 10 matches the target face image included in the request data D1 received from the automatic ticket gate 80 with a plurality of registered face images registered in the token ID information DB 11 on a one-to-N basis. Note that the registered face images to be matched are limited to images associated with a token ID whose invalidation flag value is “1” (valid).

Herein, if the management server 10 determines that the result of matching is that the matching failed (step S1005, NO), the management server 10 transmits the response data D2 including matching result information indicating the failed matching to the automatic ticket gate 80 (step S1007), and the process proceeds to step S1009. In contrast, if the management server 10 determines that the result of matching is that the matching is successful (step S1005, YES), the process proceeds to step S1006.

In step S1006, the management server 10 acquires operation information from the operation information DB 13 by using, as a key, the token ID associated with the successfully matched registered face image in the token ID information DB 11. The management server 10 then transmits the response data D2 including the matching result information, the token ID, and the operation information to the automatic ticket gate 80 (step S1008).

Next, if the automatic ticket gate 80 references the response data D2 and determines that it is possible to permit exit (step S1009, YES), the automatic ticket gate 80 opens the gate 811 (step S1010).

Next, the automatic ticket gate 80 transmits the request data D1 that requests invalidation of the token ID and registration of passage history information on the user U to the management server 10 (step S1011).

In response to receiving the request data D1 from the automatic ticket gate 80, the management server 10 updates the token ID information DB 11 (step S1012). Specifically, the management server 10 updates the invalidation flag of the token ID information DB 11 to a value of invalid (“0”). Accordingly, the validated period (lifecycle) of the token ID expires.

Next, the management server 10 registers passage history information indicating the relationship between the token ID and ticket gate passage information on the user U to the passage history information DB 12 (step S1013).

The management server 10 then transmits the response data D2 to the automatic ticket gate 80 (step S1014) and ends the process.

On the other hand, if the automatic ticket gate 80 references the response data D2 and determines that it is not possible to permit exit (step S1009, NO), the automatic ticket gate 80 notifies the user U of an error message (step S1015).

As described above, according to the present example embodiment, the management server 10 can easily apply a face authentication technology to a plurality of operations performed in railroad facilities. This increases efficiency of each operation.

Further, when the face authentication technology is used in operations in a railroad, a face image is captured when a train ticket or a limited express ticket is purchased at a mobile terminal or a ticket vending machine at a counter. When ticket inspection is performed in the train by a conductor, the conductor may use a portable operation terminal to capture a face image of the user U and upload the face image to the management server 10 via the networks NW and NW3. This enables a ticket inspection operation based on face authentication in the train TR. Note that the ticket inspection may be automatically performed by the management server 10 based on an image captured by a network camera installed inside a vehicle.

Furthermore, if a token ID and payment information are associated with each other in advance, even when boarding a train without specifying a destination or even when riding past a destination, the user may also pay the fare by using face authentication when exiting an alighting station. [Third Example Embodiment]

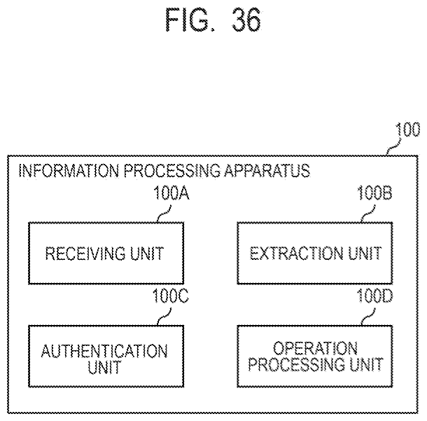

FIG. 36 is a block diagram illustrating a configuration of an information processing apparatus 100 in the present example embodiment. The information processing apparatus 100 includes a receiving unit 100A, an extraction unit 100B, an authentication unit 100C, and an operation processing unit 100D. The receiving unit 100A receives request data having control data from an operation terminal used for a predetermined operation. The extraction unit 100B extracts biometric information used for biometric authentication and encapsulated operation data from the request data based on the control data. The authentication unit 100C performs biometric authentication on a user based on the biometric information. The operation processing unit 100D processes operation data. According to the information processing apparatus 100 in the present example embodiment, a face authentication function can be easily implemented to various operations.

### Modified Example Embodiments

Although the present invention has been described above with reference to the example embodiments, the present invention is not limited to the example embodiments described above. Various modifications that can be understood by those skilled in the art can be made to the configuration and details of the present invention within the scope not departing from the spirit of the present invention. For example, it should be understood that an example embodiment in which a configuration of a part of any of the example embodiments is added to another example embodiment or an example embodiment in which a configuration of a part of any of the example embodiments is replaced with a configuration of a part of another example embodiment is also an example embodiment to which the present invention may be applied.

In the first and second example embodiments described above, the cases in which the present invention is applied to operations in an airport and a railroad have been described. However, the configuration of the present invention is applicable to operations in any types of business such as accommodation industry, service industry, manufacturing industry, or the like. For example, in application to operations in the accommodation industry, by associating a face image of a guest with operation information by a token ID at check-in to a hotel, it is possible to use face authentication to perform purchase of an item, use of a service, control of entry and exit to and from a guest room, or the like in a facility during a stay period of the user.

Although written in the JSON form in the first and second example embodiments described above, the request data D1 and the response data D2 may be written in other data formats such as an XML form. That is, any data format can be employed as long as it can encapsulate operation data.

The scope of each of the example embodiments also includes a processing method that stores, in a storage medium, a program that causes the configuration of each of the example embodiments to operate so as to implement the function of each of the example embodiments described above, reads the program stored in the storage medium as a code, and executes the program in a computer. That is, the scope of each of the example embodiments also includes a computer readable storage medium. Further, each of the example embodiments includes not only the storage medium in which the program described above is stored but also the individual program itself.

As the storage medium, for example, a floppy (registered trademark) disk, a hard disk, an optical disk, a magneto-optical disk, a CD-ROM, a magnetic tape, a nonvolatile memory card, or the like can be used. Further, the scope of each of the example embodiments also includes an example that operates on OS to perform a process in cooperation with another software or a function of an add-in board without being limited to an example that performs a process by an individual program stored in the storage medium.

The whole or part of the example embodiments disclosed above can be described as, but not limited to, the following supplementary notes.

### (Supplementary Note 1)

An information processing apparatus comprising:

a receiving unit that receives request data having control data from an operation terminal used for a predetermined operation;

an extraction unit that extracts biometric information used for biometric authentication and encapsulated operation data from the request data based on the control data;

an authentication unit that performs biometric authentication on a user based on the biometric information; and

an operation processing unit that processes the operation data.

### (Supplementary Note 2)

The information processing apparatus according to supplementary note 1 further comprising a transmission unit that transmits, to the operation terminal, response data having the control data and the operation data to which process results from the operation processing unit and the authentication unit are reflected, respectively,

wherein in the response data, the operation data is encapsulated.

### (Supplementary Note 3)

The information processing apparatus according to supplementary note 2, wherein the operation data includes a label for the operation processing unit to identify a data item.

### (Supplementary Note 4)

The information processing apparatus according to supplementary note 3 further comprising an issuance unit that issues an identifier that associates the biometric information on the user with the operation data.

### (Supplementary Note 5)

The information processing apparatus according to supplementary note 4, wherein the control data includes an execution command related to at least one of a registration process of the operation data, a search process of the operation data, an issuance process of the identifier, and the biometric authentication.

### (Supplementary Note 6)

The information processing apparatus according to supplementary note 4 or 5, wherein when the biometric information of the request data includes first biometric information acquired from the user at the operation terminal provided in an airport facility and second biometric information acquired from a passport possessed by the user,

the authentication unit matches the first biometric information with the second biometric information, and

when a result of matching performed by the authentication unit is that the matching is successful, the issuance unit sets the first biometric information as registered biometric information on the user and associates the operation data related to the passport or a boarding ticket with the registered biometric information by using the identifier.

### (Supplementary Note 7)

The information processing apparatus according to supplementary note 6, wherein when a result of matching of the first biometric information with the registered biometric information performed by the authentication unit is that the matching is successful, the response data includes the operation data associated with the registered biometric information.

### (Supplementary Note 8)

The information processing apparatus according to supplementary note 4 or 5, wherein the issuance unit sets the biometric information acquired from the user as registered biometric information on the user when a train ticket is issued at the operation terminal provided in a railroad facility and associates the operation data related to the train ticket with the registered biometric information by using the identifier.

### (Supplementary Note 9)

The information processing apparatus according to supplementary note 8, wherein when a result of matching of the biometric information with the registered biometric information performed by the authentication unit is that the matching is successful, the response data includes the operation data associated with the registered biometric information.

### (Supplementary Note 10)

The information processing apparatus according to any one of supplementary notes 1 to 9,

wherein the operation processing unit is formed of a plurality of APIs, and

wherein the extraction unit assigns the operation data to two or more of the APIs based on one of the request data.

### (Supplementary Note 11)

The information processing apparatus according to any one of supplementary notes 1 to 10, wherein the request data is written in JSON or XML.

### (Supplementary Note 12)

The information processing apparatus according to any one of supplementary notes 1 to 11, wherein the biometric information is any of a face image, an iris image, and a fingerprint image.

### (Supplementary Note 13)

An information processing method comprising:

receiving request data having control data from an operation terminal used for a predetermined operation;

extracting biometric information used for biometric authentication and encapsulated operation data from the request data based on the control data;

performing biometric authentication on a user based on the biometric information; and

processing the operation data.

### (Supplementary Note 14)

A storage medium storing a program that causes a computer to perform:

receiving request data having control data from an operation terminal used for a predetermined operation;

extracting biometric information used for biometric authentication and encapsulated operation data from the request data based on the control data;

performing biometric authentication on a user based on the biometric information; and processing the operation data.

### REFERENCE SIGNS LIST

NW network
D1 request data
D2 response data
1, 2 information processing system
10 management server
10A storage unit
10B transceiver unit
10C data extraction unit
10D matching unit
10E token ID issuance unit
10F operation processing unit
11 token ID information DB
12 passage history information DB
13 operation information DB
20 check-in terminal
30 automatic baggage check-in machine
40 security inspection apparatus
50 automated gate apparatus
60 boarding gate apparatus
70 automatic ticket vending machine
80 automatic ticket gate
90 POS terminal
100 information processing apparatus
200 edge terminal

What is claimed is:

1. An information processing apparatus comprising:
a receiving unit that receives request data having control data from an operation terminal used for a predetermined operation;
an extraction unit that extracts biometric information used for biometric authentication and encapsulated operation data from the request data based on the control data;
an authentication unit that performs biometric authentication on a user based on the biometric information; and
an operation processing unit that processes the operation data.

2. The information processing apparatus according to claim 1 further comprising a transmission unit that transmits, to the operation terminal, response data having the control data and the operation data to which process results from the operation processing unit and the authentication unit are reflected, respectively,
wherein in the response data, the operation data is encapsulated.

3. The information processing apparatus according to claim 2, wherein the operation data includes a label for the operation processing unit to identify a data item.

4. The information processing apparatus according to claim 3 further comprising an issuance unit that issues an identifier that associates the biometric information on the user with the operation data.

5. The information processing apparatus according to claim 4, wherein the control data includes an execution command related to at least one of a registration process of the operation data, a search process of the operation data, an issuance process of the identifier, and the biometric authentication.

6. The information processing apparatus according to claim 4, wherein when the biometric information of the request data includes first biometric information acquired from the user at the operation terminal provided in an airport facility and second biometric information acquired from a passport possessed by the user,
the authentication unit matches the first biometric information with the second biometric information, and
when a result of matching performed by the authentication unit is that the matching is successful, the issuance unit sets the first biometric information as registered biometric information on the user and associates the operation data related to the passport or a boarding ticket with the registered biometric information by using the identifier.

7. The information processing apparatus according to claim 6, wherein when a result of matching of the first biometric information with the registered biometric information performed by the authentication unit is that the matching is successful, the response data includes the operation data associated with the registered biometric information.

8. The information processing apparatus according to claim 4, wherein the issuance unit sets the biometric information acquired from the user as registered biometric information on the user when a train ticket is issued at the operation terminal provided in a railroad facility and associates the operation data related to the train ticket with the registered biometric information by using the identifier.

9. The information processing apparatus according to claim 8, wherein when a result of matching of the biometric information with the registered biometric information performed by the authentication unit is that the matching is successful, the response data includes the operation data associated with the registered biometric information.

10. The information processing apparatus according to claim 1,
wherein the operation processing unit is formed of a plurality of APIs, and
wherein the extraction unit assigns the operation data to two or more of the APIs based on one of the request data.

11. The information processing apparatus according to claim 1, wherein the request data is written in JSON or XML.

12. The information processing apparatus according to claim 1, wherein the biometric information is any of a face image, an iris image, and a fingerprint image.

13. An information processing method comprising:
receiving request data having control data from an operation terminal used for a predetermined operation;
extracting biometric information used for biometric authentication and encapsulated operation data from the request data based on the control data;
performing biometric authentication on a user based on the biometric information; and
processing the operation data.

14. A non-transitory storage medium storing a program that causes a computer to perform:
receiving request data having control data from an operation terminal used for a predetermined operation;
extracting biometric information used for biometric authentication and encapsulated operation data from the request data based on the control data;
performing biometric authentication on a user based on the biometric information; and
processing the operation data.
